(19) United States
(12) Patent Application Publication
(10) Pub. No.: US 2016/0234899 A1
(43) Pub. Date: Aug. 11, 2016

(54) LUMINAIRE WITH ADJUSTABLE ILLUMINATION PATTERN

(71) Applicant: Express Imaging Systems, LLC, Renton, WA (US)

(72) Inventors: William G. Reed, Seattle, WA (US); Richard Dolf, Seattle, WA (US)

(21) Appl. No.: 14/939,856

(22) Filed: Nov. 12, 2015

Related U.S. Application Data
(60) Provisional application No. 62/114,826, filed on Feb. 11, 2015.

(51) Int. Cl. H05B 33/08; H05B 37/02; F21V 29/70

(52) U.S. Cl. CPC H05B 33/0842; F21V 29/70; H05B 37/0272; H05B 37/0263; F21Y 2101/02; F21Y 2113/005

(57) ABSTRACT

Systems, methods and articles for providing illumination systems with selectively adjustable illumination patterns which reduce the need for a utility or luminaire distributer to stock luminaires with different illumination patterns and reduce the need for pre-planning installations. Illumination patterns may be adjusted wirelessly from the ground or from a central location. Implementations may allow scheduled dimming of luminaires, dimming in defined physical directions and scheduled adjustment of light patterns. The luminaires of the present disclosure may provide different light color illumination, such as amber color, in defined zones which may be required in biologically sensitive areas or other applications. Notifications, such as severe storm warning alerts, may be signaled to the public by turning on or flashing an amber colored or other colored luminaire.

### BACKGROUND

1. Technical Field

The present disclosure generally relates to illumination, and more particularly to illumination devices and systems with adjustable illumination patterns.

2. Description of the Related Art

Luminaires enjoy widespread use in a variety of industrial, commercial, and municipal applications. Such applications can include general or area lighting of workspaces, roadways, parking lots, and the like. Multiple luminaires are typically arranged in patterns and positioned at intervals sufficient to provide a minimum overall level of illumination across the area of interest. For example, luminaires may be spaced at intervals along a driveway in a multilevel parking garage to provide an overall level of illumination that permits safe ingress and egress by pedestrians as well as permits safe operation of motor vehicles within the parking garage. In a similar manner, luminaires may be spaced at intervals throughout a commercial center parking lot to promote safe operation of motor vehicles, permit safe ingress and egress by customers, and foster a sense of safety and well-being for business patrons within the commercial center. Similarly, a number of luminaires may be spaced along a roadway to provide a level of illumination permitting safe operation of motor vehicles on the roadway and, where applicable, safe passage of pedestrians on sidewalks adjoining the roadway.

To simplify power distribution and control wiring, such luminaires may be organized into groups or similar hierarchical power and control structures. For example, multiple luminaires along a roadway may be grouped together on a common power circuit that is controlled using a single, centralized controller to collectively adjust the luminous output of all of the luminaires in the group. In another instance, multiple luminaires within a parking garage may be controlled using a single photocell mounted on the exterior of the parking garage. Such installations may however compromise operational flexibility for ease of installation and simplicity of operation.

Energy conservation has become of ever-increasing importance. Efficient use of energy can result in a variety of benefits, including financial benefits such as cost savings and environmental benefits such as preservation of natural resources and reduction in “green house” (e.g., CO₂) gas emissions.

Residential, commercial, and street lighting which illuminate interior and exterior spaces consume a significant amount of energy. Conventional lighting devices or luminaires exist in a broad range of designs, suitable for various uses. Lighting devices employ a variety of conventional light sources, for example incandescent lamps, fluorescent lamps such as high-intensity discharge (HID) lamps (e.g., mercury vapor lamps, high-pressure sodium lamps, metal halide lamps).

One approach to reducing energy consumption associated with lighting systems employs higher efficiency light sources. Use of higher efficiency light sources may, for instance, include replacing incandescent lamps with fluorescent lamps or even with solid-state light sources (e.g., light emitting diodes (LEDs), organic LEDs (OLEDs), polymer LEDs (PLEDs)) to increase energy efficiency. In some instances, these higher efficiency light sources may present a number of problems. For example, fluorescent light sources may take a relatively long time after being turned ON to achieve their full rated level of output light or illumination. Such light sources also typically have a high energy consumption during warm-up. Many higher efficiency light sources emit light with a low color rendering index (CRI). For reference, sunlight has a CRI of 100 and represents “ideal light” which contains a continuous spectrum of visible radiation. Low CRI light is less pleasing to the human eye. Surfaces illuminated with low CRI light may not be perceived in their “true” color. Low CRI light makes it more difficult to discern details, often requiring a higher level of output light or illumination to discern details that would otherwise be discernable in high CRI light. Further, higher efficiency light sources may require additional circuitry (e.g., ballasts) and/or thermal management techniques (e.g., passive or active cooling).

Lighting systems are designed to have specific illumination patterns, for example, outdoor luminaires may have National Electrical Manufacturers Association (NEMA) Type 1, 2, 3, 4 or 5 illumination patterns. Indoor applications may require unique illumination patterns to properly light complex interior spaces, for example retail stores. Other non-standardized light patterns are desirable in some installations, to provide higher light levels in certain locations and lower light levels in other locations. For example, a NEMA Type 5 outdoor luminaire is designed to provide light in a square or circular pattern on the ground, whereas a NEMA Type 3 pattern has an oblong light distribution more suitable for roadway lighting. In some installations, none of the standard illumination patterns are acceptable. For example, a NEMA Type 5 luminaire mounted near a residence may properly illuminate a yard and driveway, but may also project an objectionable amount of light into the windows of the residence. In such a case the luminaire installer may receive a complaint from the resident and then return to the installation to install a light shield or mask, or paint the luminaire's refractor to reduce the objectionable light illuminating the residence. This is a very expensive alteration due to the time and cost of a “bucket truck” and service person.

Interior light distribution patterns may require more than one luminaire to achieve appropriate light levels in all areas. Most lighting stores, utilities, electric companies, rural electric cooperatives and other providers of luminaire installations stock several types of luminaires so that the proper illumination pattern luminaire will be available for installation in any situation. This is a significant expense in inventory and record keeping, and complicates the installation plan.

### BRIEF SUMMARY

A luminaire may be summarized as including a housing comprising a heat exchanger having a circuit board mounting area; at least one circuit board physically coupled to the circuit board mounting area of the heat exchanger; a number N of solid-state light emitter arrays carried on the at least one circuit board, the number N greater than or equal to two, each of the N solid-state light emitter arrays including a plurality of solid-state light emitters, at least some of the plurality of solid-state light emitters of one of the N solid-state light emitter arrays positioned at a different angle from at least some of the solid-state light emitters of at least one of the other N solid-state light emitter arrays; a solid-state light emitter driver including N independently controllable driver channels, each of the N driver channels electrically coupled to a different one of the N solid-state light emitter arrays; at least one luminaire processor operatively coupled to the solid-state light emitter driver to control the operation thereof; at least one luminaire transceiver operatively coupled to the at least one luminaire processor and to at least one data communications channel; and at least one luminaire nontransitory processor-readable storage medium operatively coupled to the at least one luminaire processor and which stores at least one of data or instructions which, when executed by the at least one luminaire processor, cause the at least one luminaire processor to: receive, via the at least one luminaire transceiver, illumination pattern information from a remotely located external processor-based system over the at least one data communications channel, the illumination pattern information indicative of an illumination pattern to be produced by the N solid-state light emitter arrays; store the received illumination pattern information in the at least one nontransitory processor-readable storage medium; and control the operation of the solid-state light emitter driver based at least in part on the illumination pattern information. The received illumination pattern information may specify an instruction to control the solid-state light emitter driver to drive at least one of the N independently controllable driver channels differently from the other of the N independently controllable driver channels. The received illumination pattern information may specify an instruction to control the solid-state light emitter driver to drive each of the N independently controllable driver channels so that the plurality of solid-state light emitters of the N solid-state light emitter arrays produce at least one of a plurality of determined standardized illumination patterns. The received illumination pattern information may specify an instruction to control the solid-state light emitter driver to drive each of the N independently controllable driver channels so that the plurality of solid-state light emitters of the N solid-state light emitter arrays produce at least one of a National Electrical Manufacturers Association (NEMA) illumination pattern or an Illuminating Engineering Society of North America (IESNA) illumination pattern. The received illumination pattern information may specify an instruction to control the solid-state light emitter driver to drive each of the N independently controllable driver channels so that each of the plurality of solid-state light emitters of at least one of the N solid-state light emitter arrays are at least one of disabled or dimmed. The circuit board mounting area of the heat exchanger may include a curved downward facing mounting surface of the housing. The circuit board mounting area of the housing may have longitudinal dimension and a lateral dimension perpendicular to the longitudinal dimension, the circuit board mounting area curved along the lateral dimension and the longitudinal dimension, and the at least one circuit board has longitudinal dimension and a lateral dimension perpendicular to the longitudinal dimension, the at least one circuit board is physically coupled to the circuit board mounting area such that the longitudinal dimension of the at least one circuit board is curved along the longitudinal dimension of the circuit board mounting area and the lateral dimension of the at least one circuit board is curved along the lateral dimension of the circuit board mounting area. The at least one circuit board may be a flexible printed circuit board.

The luminaire may further include a thermally conductive interface material positioned between at least a portion of the at least one circuit board and the circuit board mounting area. The plurality of solid-state light emitters of a first one of the N solid-state light emitter arrays may produce light of a first color, and the plurality of solid-state light emitters of a second one of the N solid-state light emitter arrays may produce light of a second color, the second color different from the first color. The first color may be white and the second color may be amber. The heat exchanger may include a boss extending downwardly from the housing, and the circuit board mounting area may include at least one surface of the boss parallel to an optical axis of the luminaire. The boss may be cylindrically shaped, and the circuit board mounting area may include a sidewall of the boss. The boss may have a four orthogonal side walls extending parallel to the optical axis of the luminaire, each of the solid-state light emitter arrays mounted adjacent a different one of the four side walls. The boss may have a N side walls extending parallel to the optical axis of the luminaire, each of the N solid-state light emitter arrays mounted adjacent a different one of the N side walls. The at least one circuit board may be at least one flexible printed circuit board and at least a portion of the circuit board mounting area may be a curved surface. The at least one luminaire transceiver may receive the illumination pattern information from the external processor-based system over at least one of a Bluetooth®, WiFi®, near field communication (NFC), ANT®, or IEEE 802.15 channel. The at least one luminaire transceiver may receive the illumination pattern information from the external processor-based system over at least one of a short-range wireless channel or a wired communications channel. The at least one luminaire transceiver may receive the illumination pattern information from the external processor-based system through at least one power-line power distribution system. The at least one luminaire transceiver may receive the illumination pattern information from at least one of a smartphone, a tablet computer, or a notebook computer. The at least one luminaire transceiver may receive the illumination pattern information from the external processor-based system over the at least one data communications channel, the illumination pattern information indicative of a notification illumination pattern to be produced by the N solid-state light emitter arrays, the notification illumination pattern provides a notification to humans that view the luminaire when the plurality of solid-state light emitters are illuminated according to the notification illumination pattern.

A method of operation for a luminaire may be summarized as including providing a luminaire that includes: a housing comprising a heat exchanger having a circuit board mounting area; at least one circuit board physically coupled to the circuit board mounting area of the heat exchanger; a number N of solid-state light emitter arrays carried on the at least one circuit board, the number N greater than or equal to two, each of the N solid-state light emitter arrays including a plurality of solid-state light emitters, at least some of the plurality of solid-state light emitters of one of the N solid-state light emitter arrays positioned at a different angle from at least some of the solid-state light emitters of at least one of the other N solid-state light emitter arrays; a solid-state light emitter driver including N independently controllable driver channels, each of the N driver channels electrically coupled to a different one of the N solid-state light emitter arrays; at least one luminaire processor operatively coupled to the solid-state light emitter driver to control the operation thereof; at least one luminaire transceiver operatively coupled to the at least one luminaire processor and to at least one data communications channel; and at least one luminaire nontransitory processor-readable storage medium operatively coupled to the at least one luminaire processor; receiving, by the at least one luminaire transceiver, illumination pattern information from a remotely located external processor-based system over the at least one data communications channel, the illumination pattern information indicative of an illumination pattern to be produced by the N solid-state light emitter arrays; storing the received illumination pattern information in the at least one nontransitory processor-readable storage medium; and controlling the operation of the solid-state light emitter driver based at least in part on the illumination pattern information. Receiving illumination pattern information may include receiving an illumination pattern information that specifies an instruction to control the solid-state light emitter driver to drive at least one of the N independently controllable driver channels differently from the other of the N independently controllable driver channels. Receiving illumination pattern information may include receiving an illumination pattern information that specifies an instruction to control the solid-state light emitter driver to drive each of the N independently controllable driver channels so that the plurality of solid-state light emitters of the N solid-state light emitter arrays produce a determined standardized illumination pattern. Receiving illumination pattern information may include receiving an illumination pattern information that specifies an instruction to control the solid-state light emitter driver to drive each of the N independently controllable driver channels so that the plurality of solid-state light emitters of the N solid-state light emitter arrays produce at least one of a

National Electrical Manufacturers Association (NEMA) illumination pattern or an Illuminating Engineering Society of North America (IESNA) illumination pattern. Receiving illumination pattern information may include receiving an illumination pattern information that specifies an instruction to control the solid-state light emitter driver to drive each of the N independently controllable driver channels so that each of the plurality of solid-state light emitters of at least one of the N solid-state light emitter arrays are disabled.

The method wherein the plurality of solid-state light emitters of a first one of the N solid-state light emitter arrays produce light of a first color, and the plurality of solid-state light emitters of a second one of the N solid-state light emitter arrays may produce light of a second color, the second color different from the first color, the method may further include controlling the operation of the solid-state light emitter driver based at least in part on the illumination pattern information to cause the luminaire to emit light of at least one of the first color or the second color. Receiving illumination pattern information may include receiving illumination pattern information from the external processor-based system over at least one of a Bluetooth®, WiFi®, near field communication (NFC), ANT®, or IEEE 802.15 channel. Receiving illumination pattern information may include receiving illumination pattern information from the external processor-based system over at least one of a short-range wireless channel or a wired communications channel. Receiving illumination pattern information may include receiving illumination pattern information from the external processor-based system through at least one power-line power distribution system. Receiving illumination pattern information may include receiving illumination pattern information from at least one of a smartphone, a tablet computer, or a notebook computer. Receiving illumination pattern information may include receiving illumination pattern information from the external processor-based system over the at least one data communications channel, the illumination pattern information indicative of a notification illumination pattern to be produced by the N solid-state light emitter arrays, the notification illumination pattern providing a notification to humans that view the luminaire when the plurality of solid-state light emitters are illuminated according to the notification illumination pattern.

A mobile control system (MCS) to provide illumination pattern information to a luminaire, the luminaire including a number N of solid-state light emitter arrays that each include a plurality of solid-state light emitters, the luminaire further including at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor, may be summarized as including at least one MCS processor; at least one MCS transceiver operatively coupled to the at least one MCS processor and to at least one data communications channel; and at least one MCS nontransitory processor-readable storage medium operatively coupled to the at least one MCS processor and storing at least one of data or instructions which, when executed by the at least one MCS processor, cause the at least one MCS processor to: send, via the at least one MCS transceiver, illumination pattern information to the luminaire over the at least one data communications channel for storage on the at least one luminaire nontransitory processor-readable storage medium, the illumination pattern information indicative of an illumination pattern to be produced by the N solid-state light emitter arrays. The data communications channel may include at least one of a Bluetooth®, WiFi®, near field communication (NFC), ANT®, or IEEE 802.15 channel. The MCS may include at least one of a smartphone, a tablet computer, or a notebook computer.

A method of operation to control a plurality of remotely located luminaires in an illumination system, each of the plurality of luminaires including a number N of solid-state light emitter arrays that each include a plurality of solid-state light emitters, at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor, may be summarized as including for each of the plurality of luminaires, positioning a mobile control system (MCS) proximate the luminaire, the MCS storing illumination pattern information indicative of an illumination pattern to be produced by the N solid-state light emitter arrays of the luminaire; sending, by the MCS, the illumination pattern information to the luminaire over at least one data communications channel; and storing, by at least one luminaire processor of the luminaire, the illumination pattern information in a nontransitory processor-readable storage medium. Sending illumination pattern information may include sending illumination pattern information through at least one wireless communications channel. Sending illumination pattern information may include sending illumination pattern information through at least one power-line power distribution system. Sending illumination pattern information to the luminaire may include sending illumination pattern information to the luminaire via at least one of a smartphone, tablet computer, or notebook computer.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic block diagram of a luminaire, according to at least one illustrated embodiment.

FIG. 2 is a bottom perspective view of a luminaire with a lens thereof separated from a housing of the luminaire, according to at least one illustrated embodiment.

FIG. 3 is a bottom plan view of the luminaire of FIG. 2, according to at least one illustrated embodiment.

FIG. 4 is a bottom perspective view of a luminaire with a lens thereof separated from a housing of the luminaire, according to at least one illustrated embodiment.

FIG. 5 is a bottom plan view of the luminaire of FIG. 4, according to at least one illustrated embodiment.

FIG. 6 is a top plan view of the luminaire of FIG. 4, showing an illumination pattern thereof, according to at least one illustrated embodiment.

FIG. 7A is a bottom plan view of a luminaire, according to at least one illustrated embodiment.

FIG. 7B is a right side elevational sectional view of the luminaire of FIG. 7A, according to at least one illustrated embodiment.

FIG. 8A is a partially exploded bottom perspective view of the luminaire of FIG. 7A, according to at least one illustrated embodiment.

FIG. 8B is a partially exploded right side elevational sectional view of the luminaire of FIG. 7A, according to at least one illustrated embodiment.

FIG. 9 is a luminaire management map depicting the locations of numerous luminaires, luminaire information for the luminaires, and illumination patterns for the luminaires, according to at least one illustrated embodiment.

FIG. 10 is a schematic view of an environment in which a luminaire management system may be implemented, according to at least one illustrated embodiment.

FIG. 11 is a functional block diagram of the luminaire management system of FIG. 10, according to at least one illustrated embodiment.

FIG. 12 is a functional block diagram of a mobile control system and a luminaire associated with the luminaire management system of FIG. 10, according to at least one illustrated embodiment.

FIG. 13 is a flow diagram showing a method of operation of a processor-based device to provide luminaires in an illumination system with illumination pattern information, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the various embodiments have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Additionally, the terms “lighting,” “luminous output” and “illumination” are used herein interchangeably. For instance, the phrases “level of illumination” or “level of light output” have the same meanings In addition, for instance, the phrases “illumination source” and “light source” have the same meanings

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the embodiments.

Implementations of the present disclosure are directed to systems and methods that eliminate or reduce the need for a utility or luminaire distributer to stock luminaires with different illumination patterns and reduce or eliminate the need for pre-planning installations. Further, one or more implementations disclosed herein may allow for adjusting illumination patterns of luminaires wirelessly from the ground or from a central location using a supervisory control and data acquisition (SCADA) system, and provide for a wider variety of illumination patterns than the standardized patterns. Such adjustments may be made in response to customer complaints about a particular lighting pattern or in response to a change in the area to be illuminated, for example.

In addition, one or more implementations of the present disclosure allow scheduled dimming of luminaires, dimming in defined physical directions and scheduled adjustment of light patterns. The luminaires of the present disclosure may provide different light color illumination, such as amber color, in defined zones which may be required in biologically sensitive areas or other applications. As another example, notifications, such as severe storm warning alerts, may be signaled to the public by turning on or flashing an amber colored or other colored LED arrays.

Generally, implementations of the present disclosure provide a solid-state luminaire that includes one or more arrays of one or more solid-state light sources (e.g., LEDs) each. The luminaires may include an LED driver that includes an output channel for each of the LED arrays and on/off and/or dimming control for each LED driver channel. The luminaires may also include a controller capable of adjusting the dimming level or on/off state of one or more of the driver channels, and a communications method (wired or wireless) or a physical input, such as a switch, which sets dimming schedules and levels for each LED driver channel. The luminaires may further include support circuitry such as voltage surge suppression and electromagnetic interference (EMI) filtering, a housing and lens or cover window, and a photo sensor coupled to the controller for local “dusk to dawn” control of the light output. The luminaires may also include various hardware components for mounting the luminaires in the field.

Light emitted from LEDs of the LED arrays may be directed by the physical position of each of the LED arrays in the luminaire, and/or by reflective, refractive or diffractive optics, such that different areas may be illuminated when a respective LED driver channel is enabled or the dimming value of the LED driver channel is changed. The areas illuminated by the individual LED arrays may overlap partially or completely, or may be separate.

In some implementations of the present disclosure, the communications method is via a power line carrier (PLC) or a power line data communication system. In these implementations, decoupling and filtering circuits may extract data from power lines for use by PLC or power line data systems, and transmitters/drivers may insert data into a power line for communication over the power line. Such features are discussed in detail below.

In some implementations, the communications method is wireless control such as Bluetooth®, WiFi®, Zigbee®, or the like. In these implementations, the illumination pattern of a luminaire may be adjusted either in the field by use of a smart device or appliance, such as a smart phone, tablet computer or notebook computer, during installation and/or after installation. For example, if a customer has complained about light trespass, a minimally trained worker may be dispatched to the site, and may use a smart appliance to dim the light output on a side of one or more luminaires toward the area of trespass. Additionally or alternately, the light pattern of a luminaire may be adjusted at a central location prior to installation or after installation using the smart appliance or a computer with wired or wireless networking capabilities.

In some implementations, a luminaire may have four white light emitting LED arrays and a four-channel LED driver operative to enable/disable and/or dim the LEDs on the four respective LED arrays. As discussed further below, the LED arrays and optics may be arranged such that the LED arrays direct light toward the four ordinate directions from a luminaire's mounting axis. For example, if the mounting axis is perpendicular to a street, a first LED array may illuminate in the direction crossing the street, a second LED array may illuminate in the direction of a sidewalk/house, a third LED array may illuminate in one direction of the traffic flow, and a fourth LED array may illuminate in the other direction of traffic flow. By orienting the light output from the LED arrays in this manner, various light patterns (e.g., NEMA Type 1, NEMA Type 2, NEMA Type 3, NEMA Type 4, NEMA Type 5) may be substantially produced by the luminaire. In any of the produced illumination patterns, a portion of or the entire luminaire output may be dimmed by dimming one or more of the LED driver channels.

For example, a drive current or a pulse width modulated (PWM) duty cycle of each of the LED arrays may be set to substantially the same value, thereby setting the light output of each of the LED arrays to be substantially equal. In this example, equal light output of all the LED arrays of a luminaire may form a NEMA Type 5 light pattern on the ground. Alternatively, some of the LED arrays may be dimmed or turned off completely so that the luminaire generates other types of standardized or custom illumination patterns.

The luminaires of the present disclosure may be programmed to generate standard beam shapes such as Illuminating Engineering Society of North America (IESNA) or NEMA beam types as well as individually customized beam shapes, including shapes having uneven light distribution with added or subtracted amounts of light in small areas.

In some implementations, a diffuse window or lens placed over the LED arrays forms a weather shield and diffuses the LED light such that an aesthetically pleasing light pattern is formed, without visual “hot spots” or other objectionable irregularities in light output.

In another implementation, a luminaire may include a number (e.g., three) of LED arrays which are amber color emitting LED arrays positioned on a house facing side of the luminaire and the two street facing sides of the luminaire perpendicular to the mounting axis of the luminaire, and one white light emitting LED array on the street facing side of the luminaire. This implementation may be programmed by local wireless communications via a smart appliance for scheduled dimming, such that the white light emitting LED array may be turned off during a biologically sensitive season, for example, a sea turtle egg laying/hatching season. Additionally, in this example, the number of amber LED arrays may be dimmed during this season.

In some implementations, the multiple LED arrays may be assembled or carried on one printed circuit board (PCB) or may be assembled or carried on separate PCBs. For example, the LED arrays may be assembled on one or more flexible PCBs which may be attached to a mounting area on the luminaire by thermally conductive adhesive, or other attachment method. The mounting area may be a flat plane, a raised polygon, a raised curved or cylindrical boss, or a convex and/or concave surface, for example. Light distribution for a particular illumination pattern may be made by selecting the appropriate shape of mounting surface during manufacturing of the luminaire. Further, one or more refractive, diffractive or reflective optical elements may be used to direct the light from the LED arrays to form the appropriate illumination pattern.

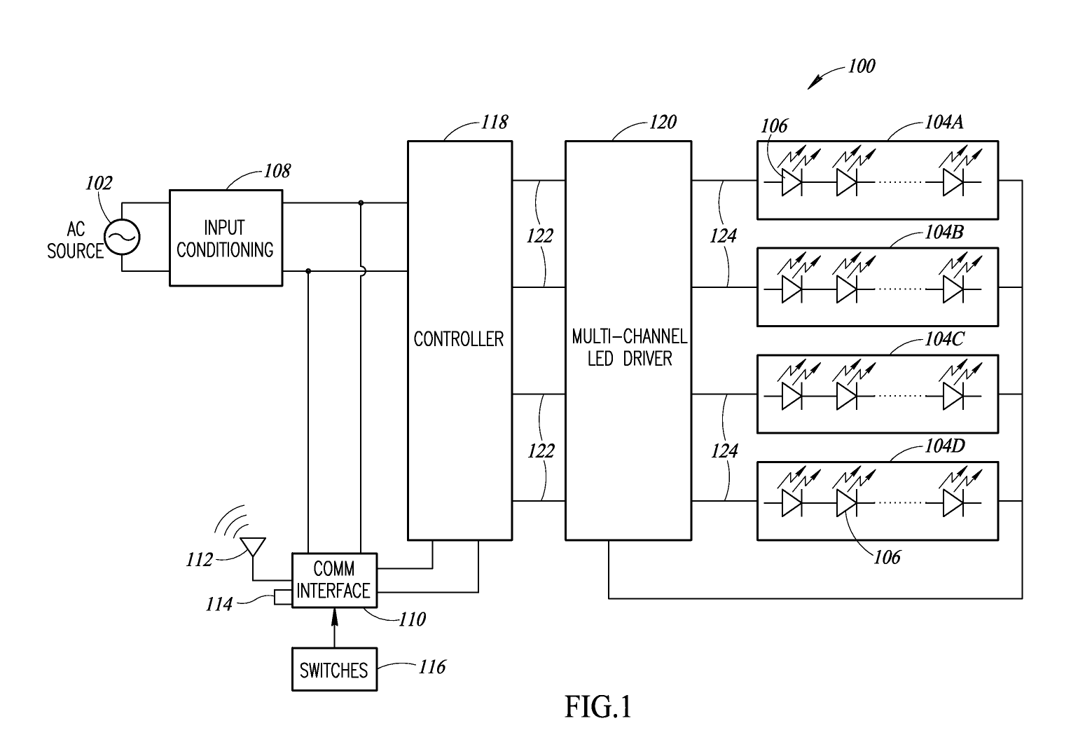

FIG. 1 shows a schematic block diagram of a luminaire 100 coupled to an alternating current (AC) power source 102 in accordance with an implementation of the present disclosure. The luminaire 100 includes four LED arrays 104A-104D (collectively LED arrays 104) each including a plurality of LEDs 106. The luminaire 100 includes input conditioning circuitry 108 coupled to the AC power source 102 which may include voltage surge suppression devices, such as metal oxide varistors (MOV), electrical noise filtering circuitry, and/or over current protection circuitry.

The luminaire 100 may also include a communications interface or control input section 110 connected to a wireless input 112 (e.g., transceiver), a wired input 114 (e.g., universal serial bus (USB)), or a mechanical switch input 116 which are used to set or control the operational mode of the luminaire. The luminaire 100 may also include a controller 118 in the form of a processor-based microcontroller or other logic element or elements, as discussed further below.

The communications interface 110 may permit wireless communication, wired communication or other methods for controlling the brightness and/or other characteristics of the LEDs 106 of the LED arrays 104. For example, a “0 to 10V” dimming control may be incorporated. As another example, a Bluetooth® Smart wireless control may be provided. A photo control to switch the luminaire 100 on or off depending upon the natural ambient light may also be incorporated. A ZigBee° wireless interface may be used for communication between individual luminaires, or between a base station (not shown) and the luminaires, or between a smart appliance and the luminaires, to control the operation and/or other characteristics of the luminaires.

The luminaire 100 may also include a multichannel LED driver 120 operatively coupled to the controller 118. The LED driver 120 may take one of many forms, for example, a primary power converter followed by two or more individual drivers, or a primary power converter connected to two or more secondary output converters. As an example, the primary converter may be a power factor corrector (PFC) with a high voltage bus, for example a 450 VDC bus. In this example, the secondary converters may be Buck, Flyback, LLC Resonant, or any other switching power down-converter topology, for example. As another example, a non-switching power controller, such as a directly connected “AC LED,” with a suitable semiconductor switch added to control output light level, may also be used.

One or more channels of the LED driver 120 may be adjustable by a signal or signals 122 provided by the controller 118 so that power delivered to the LED arrays 104 connected to the respective channels of the LED driver via wires 124 may be controlled, thereby changing the light output from a particular LED array. The signal or signals 122 may be a pulse width modulated (PWM) signal, a 0 V to 10 V analog signal, an I²C signal, or any other suitable control signal.

The channel power control for the LED driver 120 may be implemented, for example, by adjusting an analog current sink, an analog current source, a solid-state switch positioned in the low side or high side of the current path of each of the LED array 104, or by an integrated circuit input control of the controller 118, such as a “dimming input” or enable input. PWM dimming may also be used.

Dimming levels of each LED driver channel of the LED driver 120 may be adjusted by the controller 118 to set the illumination pattern for the luminaire. For example, a NEMA Type 5 illumination pattern may be obtained by setting all LED driver channels to the same drive current. If, for example, it is determined that the luminaire 100 causes an undesirable amount of light “trespass” for a residence located proximate the luminaire, the NEMA Type 5 lighting pattern may be modified by adjusting the light output of the LED driver channel that illuminates the “residence side” of the illumination pattern to output a lower level of light to decrease light “trespass” illumination of the residence.

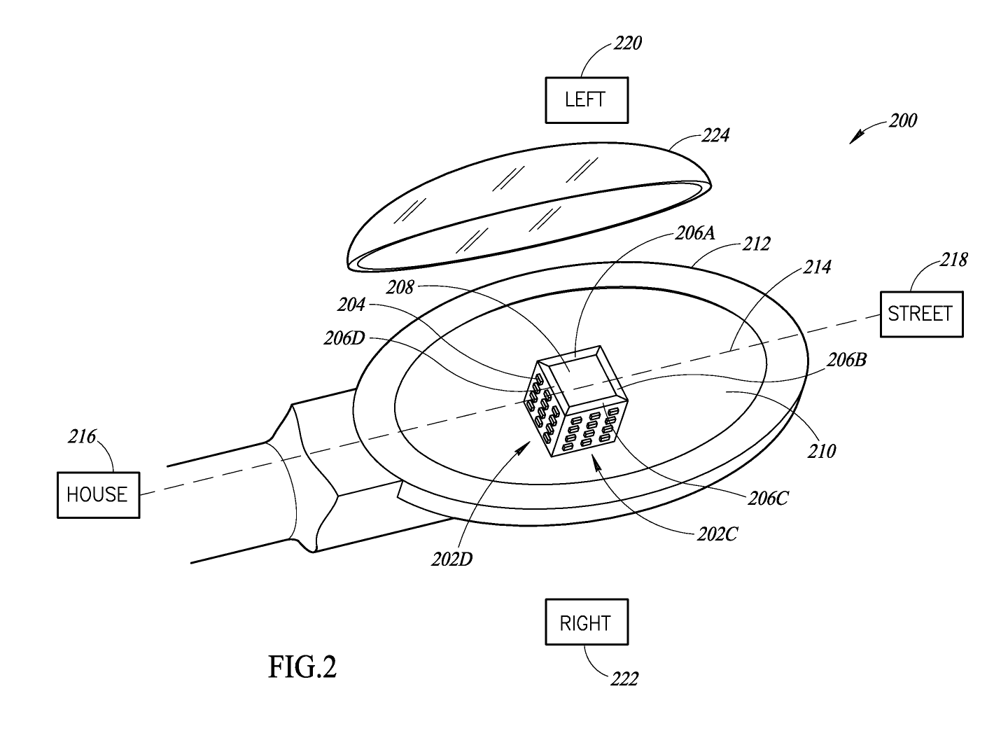

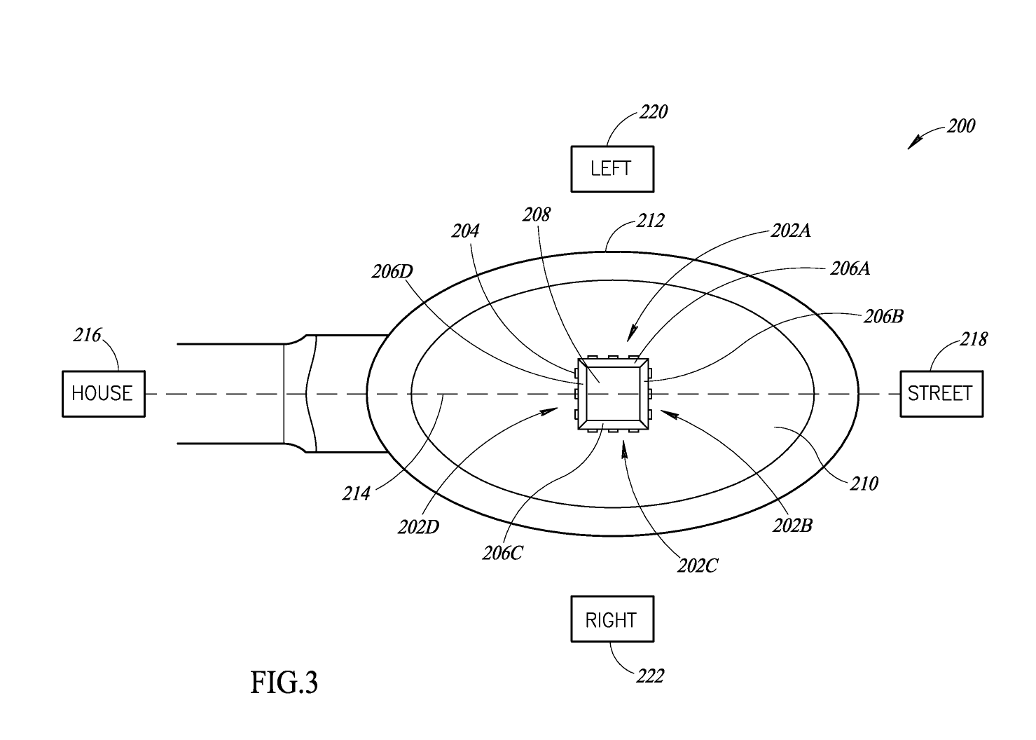

FIGS. 2 and 3 show an implementation of a luminaire 200 having four LED arrays 202A-202D (FIG. 3), wherein each of the LED arrays have a plurality of LEDs 204. The LED arrays 202A-202D are assembled on four printed circuit boards 206A-206D, respectively, with thermally conductive adhesive used for both mounting and thermal interface to a cuboid shaped boss or heat exchanger 208 of the luminaire 200 that projects downward from an interior reflective surface 210 of a housing 212. The boss or heat exchanger 208 may be physically and thermally coupled to the housing 212 so that heat from the heat exchanger may be dissipated through the housing. In some implementations, the printed circuit boards 206 may comprise a single flexible circuit board “wrapped” around the heat exchanger 208. The LED arrays 202 are arranged such that the LEDs 204 direct light toward the four ordinate directions from a mounting axis 214 of the luminaire 200 that is perpendicular to a street when the luminaire is installed. The mounting axis 214 for the luminaire 200 is shown in FIGS. 2 and 3. Additionally, a house side 216, front street side 218, left street side 220, and a right street side 222 of the luminaire 200 are shown as per the NEMA outdoor light pattern standards.

A lens 224 (FIG. 2) may be mounted on the housing 212 for weather protection and light diffusion. The lens 224 is shown as being separated from the housing 212 for explanatory purposes. The lens 224 may be placed around the LED arrays 202 to protect the LEDs 204 from moisture or other physical damage, and to diffuse light generated by the LEDs so that the light has a pleasing appearance. The lens 224 may include refractive or diffractive properties which may be used to produce a desired light pattern. In addition, the lens 224 may be coated with a dielectric reflective coating that selectively reflects some wavelengths of light while transmitting other wavelengths of light. In some implementations, there may be a reflective surface around the LEDs 204 that is coated with a wavelength converting phosphor that changes the color temperature of the emitted light in order to provide a more useful or pleasing appearance.

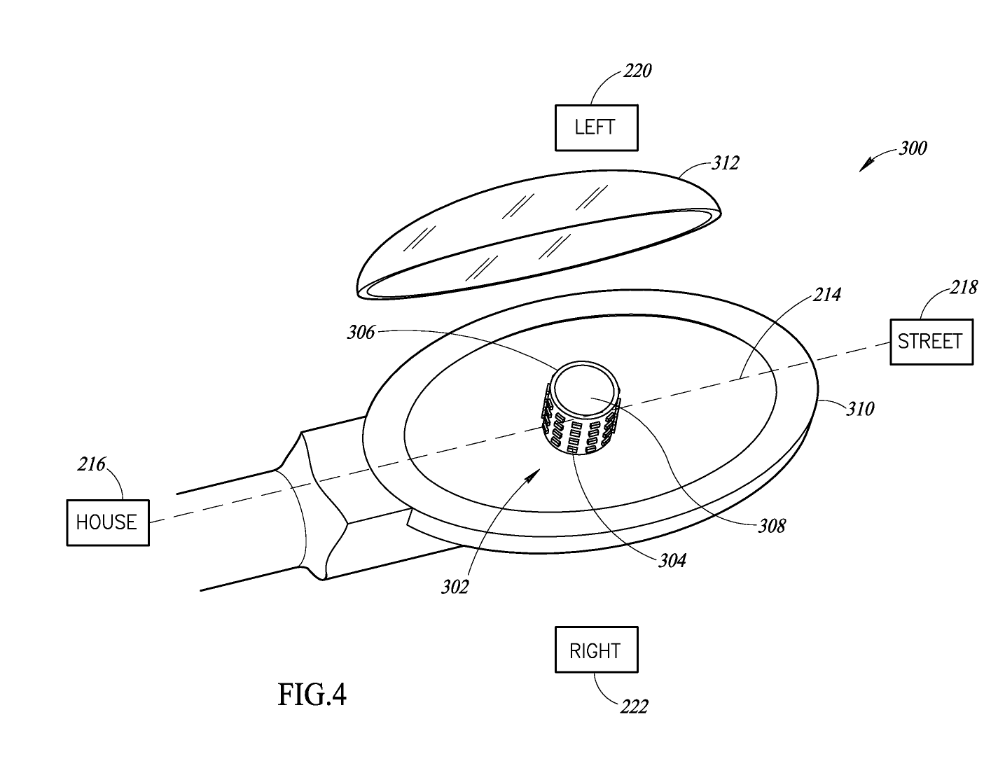

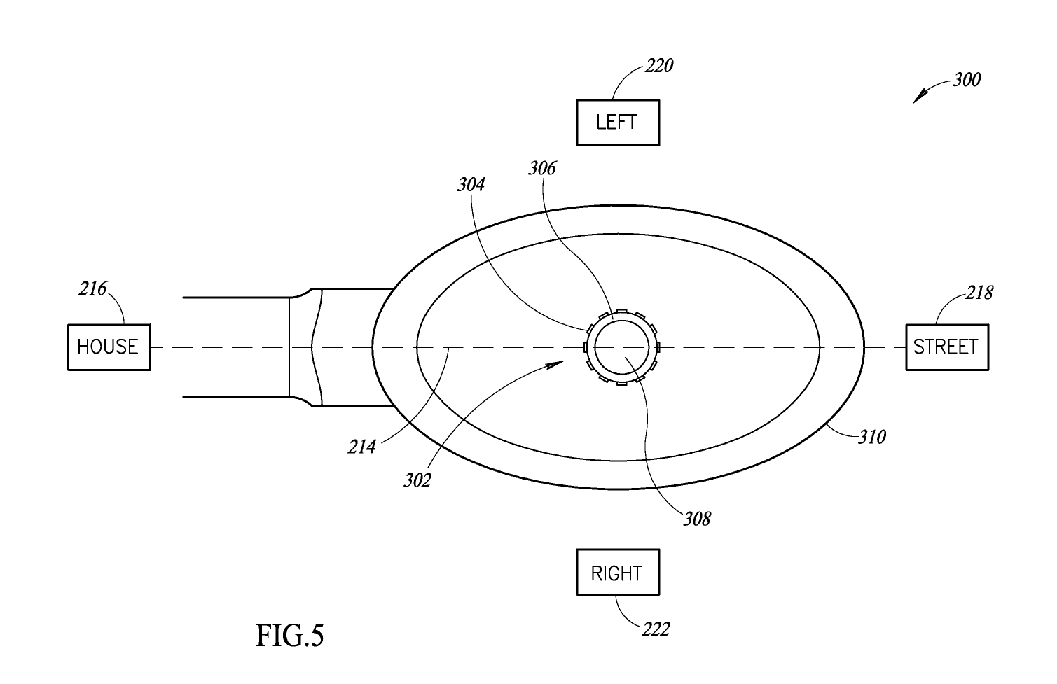

FIGS. 4 and 5 show another implementation of a luminaire 300 that includes one or more LED arrays 302 each having a plurality of LEDs 304. The LED arrays 302 are positioned on a flexible circuit board 306 disposed around a cylindrically shaped boss or heat exchanger 308 positioned within an interior of a vessel collectively defined by a housing 310 and a lens 312 (FIG. 4). The plurality of LEDs 304 are carried by the circuit board 306 and arranged to generate light to pass through the lens 312 during operation. The LEDs 304 each have a respective principal axis of emission, which typically extends perpendicularly from an outer surface of the LEDs. In this implementation, the LEDs 304 are advantageously arrayed about a central or longitudinal axis, with their respective principal axes of emission extending radially outward from the central or longitudinal axis, for example in a 360° pattern.

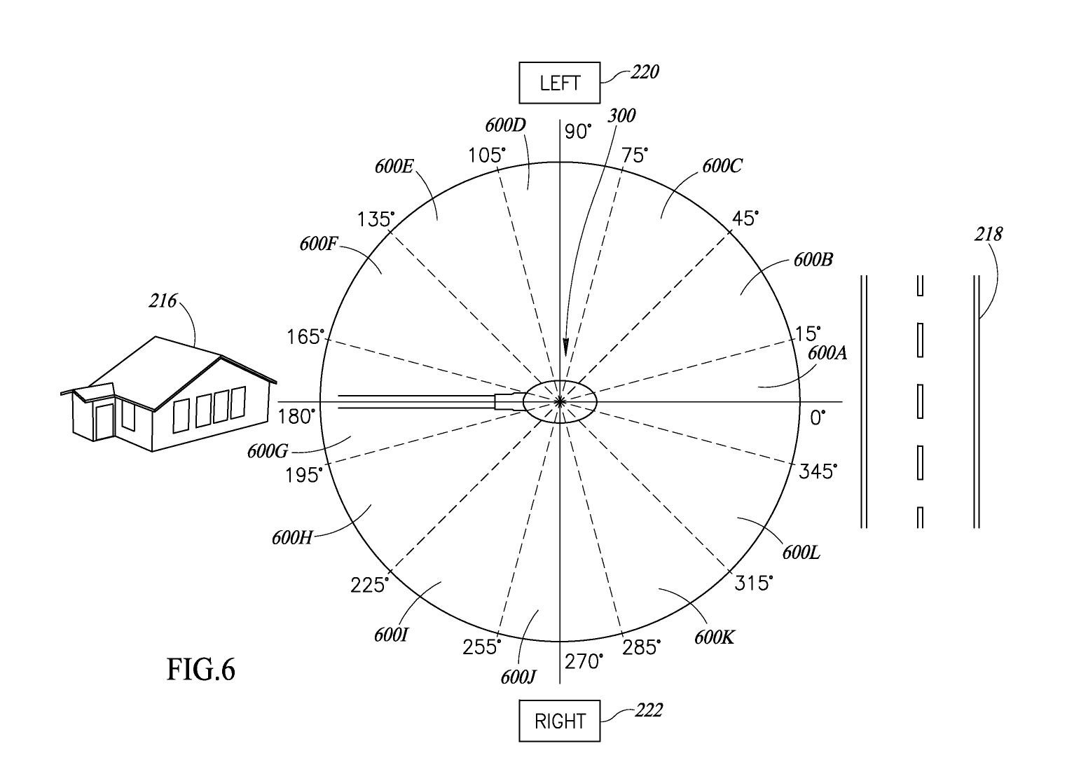

In some implementations, the LEDs 304 may be grouped into a plurality of individually controllable LED arrays 302. For example, in the illustrated implementation the LEDs 304 are arranged in 12 vertical columns spaced about the central axis of the cylindrically shaped heat exchanger 308. In some implementations, each of the 12 columns may be individually controllable by a channel of an LED driver, such as the LED driver 120 shown in FIG. 1. As shown in FIG. 6, each of the 12 LED arrays 302 may be used to control illumination in respective areas 600A-600L around the luminaire 300. In the illustrated implementation, each of the areas 600A-600L includes a 30° section of area around the luminaire 300. In practice, each of the areas 600A-600L may be overlapping or non-overlapping. Additionally, in some implementations the 12 LED arrays may be grouped into fewer or more individually controllable LED arrays 302. For example, in some implementations, the luminaire 300 may include four individually controllable LED arrays that each include three adjacent columns of the 12 columns of LEDs spaced about the heat exchanger 308. In such implementation, each LED array 302 may be used to control illumination over approximately a 90° section of area around the luminaire, similar to the luminaire of FIGS. 2 and 3.

The LEDs 304 may be mounted on the flexible or bendable printed circuit board 306 or may be mounted on individual rigid printed circuit boards and attached or secured to the heat exchanger 308 to dissipate heat generated by the LEDs 304. In some implementations, a single flexible or bendable printed circuit board may be disposed completely or nearly completely about a central or longitudinal axis, to form an annulus. In other implementations, a plurality of rigid printed circuit boards may be disposed completely or nearly completely about a central or longitudinal axis, each constituting a respective facet of a polygonal annular shape about the central or longitudinal axis. In yet another implementation, a plurality of flexible or bendable printed circuit boards may be disposed completely or nearly completely about a central or longitudinal axis, each constituting a respective facet of a polygonal annular shape. Use of flexible or bendable printed circuit boards may reduce the total number of facets on the polygonal annular shape. A thermal interface material, such as thermally conductive adhesive or grease, self-adhesive thermally conductive tape, or other such material may be placed between the heat exchanger and the printed circuit board to secure the printed circuit board to the heat exchanger and/or to increase heat conduction from the circuit board to the heat exchanger.

In other implementations, the LEDs 304 may be arranged in various other linear or non-linear arrangements. In some instances, greater quantities of low or mid power LEDs may be used in place of higher power (e.g., >1 watt) LEDs to make the collective light source more diffused and/or lower the manufacturing cost of the device. As an example, in some implementations, an array of LEDs may be provided on one or more flexible or bendable printed circuit boards having up to or more than 100 individual LEDs. The one or more circuit boards may be attached or secured to a heat exchanger, such as the heat exchanger 308 shown in FIGS. 4 and 5, to dissipate heat generated by the LEDs.

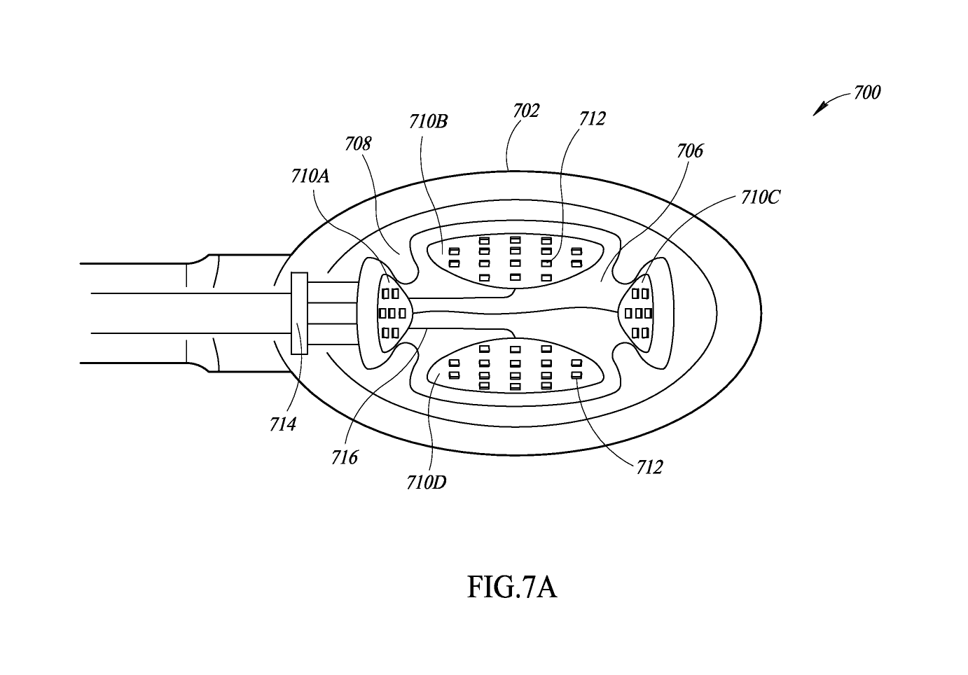

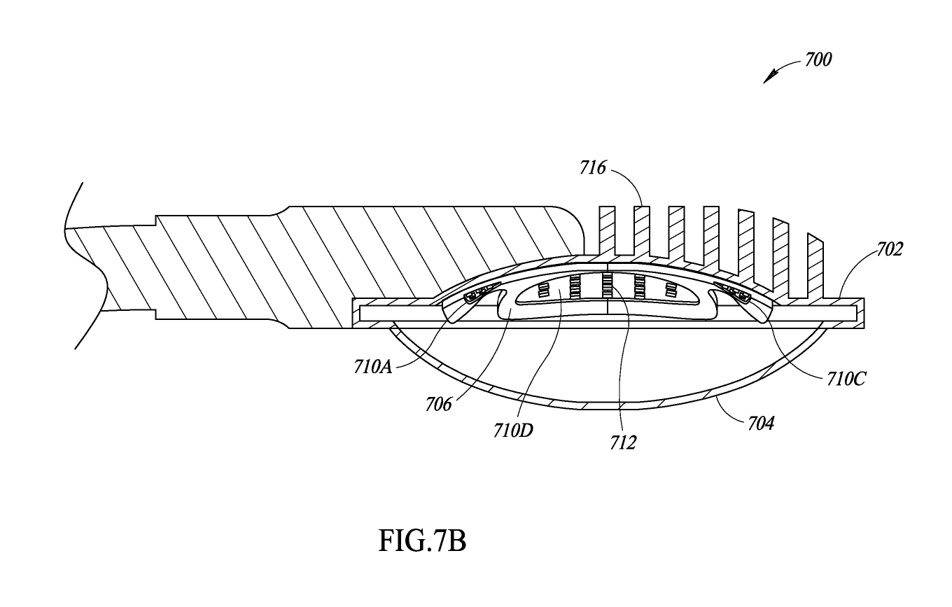

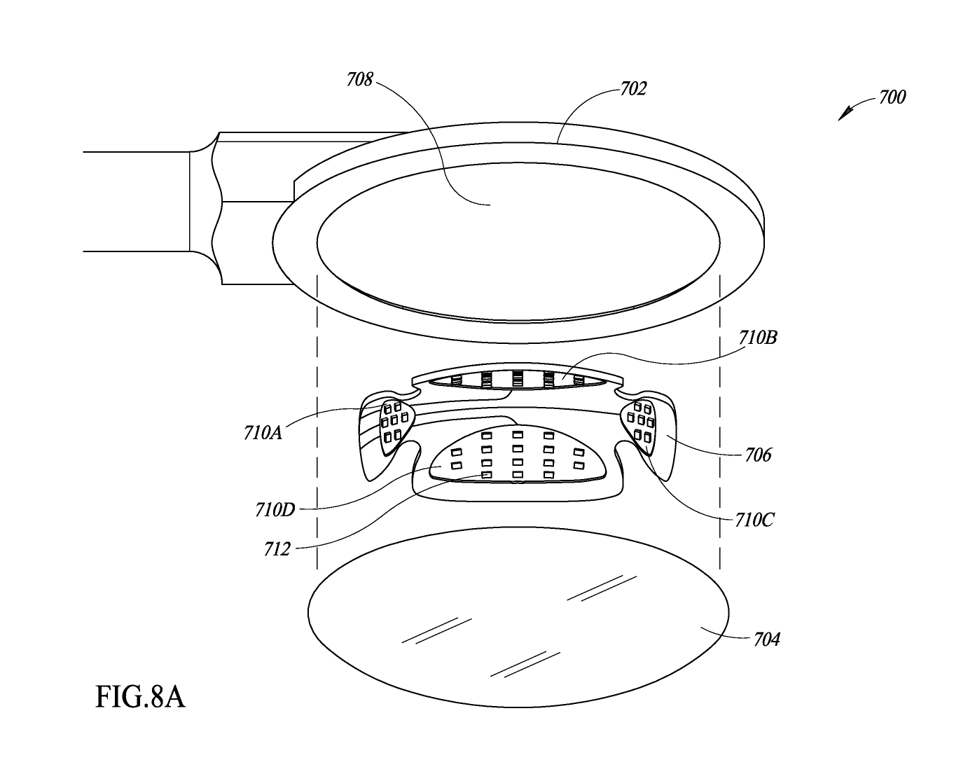

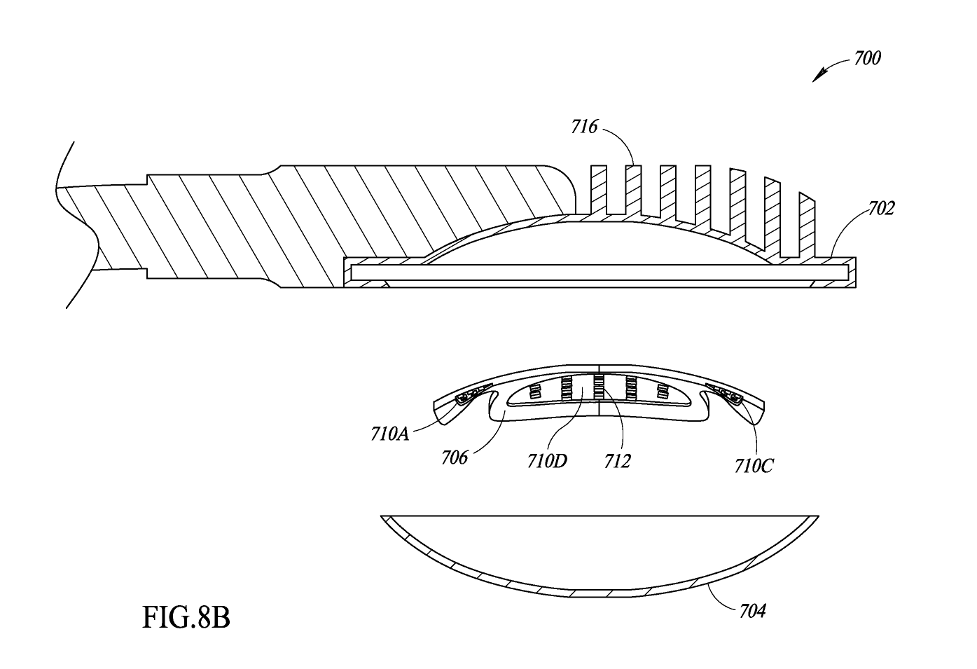

FIGS. 7A-7B and 8A-8B show another implementation of a luminaire 700. The luminaire 700 includes a housing 702 and a lens 704 that together form an interior vessel. The luminaire 700 includes a flexible PCB 706 coupled a downward facing mounting surface 708 of the housing 702 via a suitable adhesive, such as a thermally conductive pressure sensitive adhesive. The flexible PCB 706 includes four LED arrays 710A-710D each having a plurality of LEDs 712. Each of the LED arrays 710 is coupled to a multi-channel LED driver 714 via suitable electrical wires 716. The multi-channel LED driver 714 may be similar or identical to the LED driver 120 of FIG. 1 discussed above.

The housing 702 functions as a heat exchanger for the LEDs 712. As shown, the housing 702 may include a plurality of fins 716 (FIG. 7B), projections, surface treatment, or other features that increase the effective surface area of the housing to enhance its cooling capabilities. In some implementations, the housing 702 may be coated with a nanoparticle surface treatment to increase thermal radiation from its surface.

The downward facing mounting surface 708 of the housing 702 may be concave shaped and the flexible PCB 706 may be shaped during installation to match the shape of the mounting surface. In other embodiments, the mounting surface 708 may be convex shaped, planar, or any combination thereof. The mounting surface 708 may be faceted or may have a curvature with a constant radius or otherwise. Other implementations may use discrete PCBs wired together which are mounted to the mounting surface 708 of the housing 702, or a bendable metal core PCB which is bent or folded to conform to the mounting surface of the housing.

The shape of the mounting surface 708 at least partially determines the illumination pattern of the luminaire 700. For example, in implementations where the mounting surface 708 has a relatively large degree of concavity, the illumination pattern is relatively narrow, whereas in implementations where the mounting surface has a relatively low small degree of concavity, the illumination pattern is relatively spread out. Thus, during manufacturing the shape of the mounting surface 708 may be selected to provide a desired illumination pattern. Moreover, as discussed above, the illumination of each of the four LED arrays 710A-710D may be controlled individually, which allows for numerous illumination patterns for the luminaire 700 after installation of the luminaire.

In the implementation illustrated in FIGS. 7A-7B and 8A-8B, the curved mounting surface 708 is concave about multiple axes (e.g., a longitudinal axis and a lateral axis). In other implementations, the mounting surface 708 may be concave about one or more axes (e.g., doubly concave) or may be convex about one or more axes.

The flexible or rigid circuit boards discussed herein may include one or more layers of an electrically insulative or dielectric material. Common materials include FR2, FR3, FR4, aluminum core (ThermaCore, Inc.; Bregquist, Inc.). The circuit boards may include one or more electrically conductive paths carried on one or more layers, or through one or more layers by vias or through holes. Electrically conductive paths may, for example, take the form of one or more traces of electrically conductive material. The circuit boards may take the form of a printed circuit board.

The housings and/or heat exchangers (“heat sinks”) discussed herein may take a variety of forms suitable for transferring heat from a solid (e.g., solid-state light sources) to a fluid (i.e., gas or liquid). The heat exchangers may have a dissipation portion which typically includes a relatively large surface area, allowing dissipation of heat therefrom to a fluid (e.g., ambient environment) by convective and/or radiant heat transfer. The dissipation portion may, for example, include one or more protrusions. In some implementations, the protrusions may take the form of fins or pin fins. The heat exchangers may comprise a metal (e.g., aluminum, aluminum alloy, copper, copper alloy) or other high thermal conductivity material. The heat exchangers may, for example, have a thermal conductivity of at least 150 Watt per meter Kelvin (W/mK).

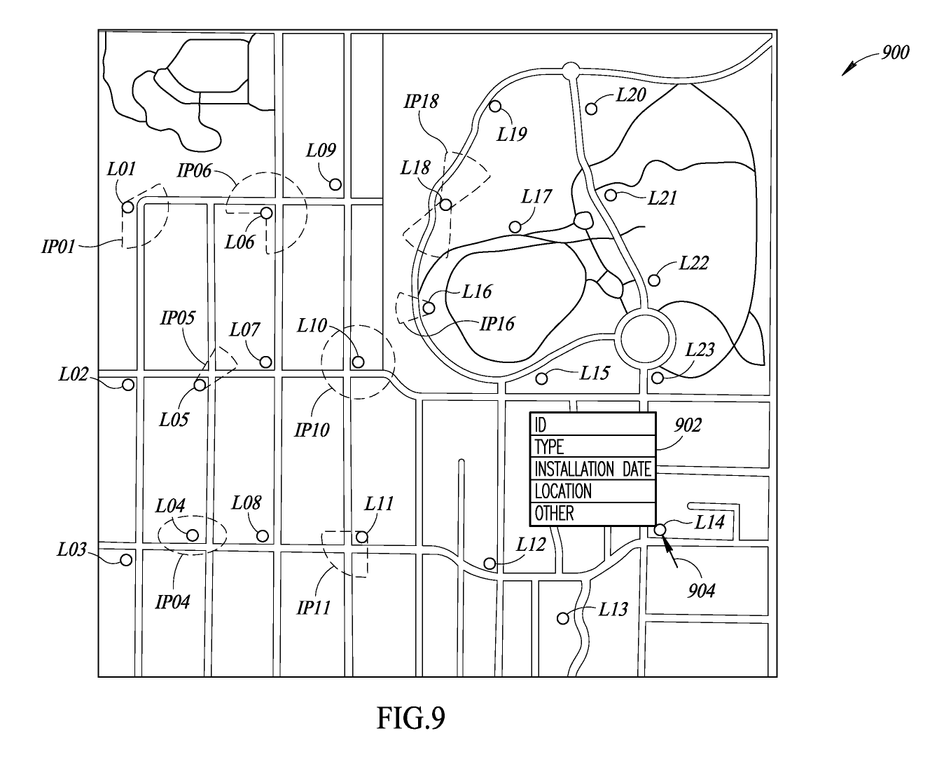

FIG. 9 illustrates a map 900 that may be viewable by a processor-based device associated with an illumination system. The map 900 depicts a plurality of icons L01-L23 for plurality of respective luminaires positioned at various locations throughout a geographical area (e.g., a city). The map 900 may be displayed to a user on an output device (e.g., a monitor, touchscreen) of a computing device operative to receive data from the central asset management system.

The map 900 may display a window 902 that includes luminaire information for one or more luminaires of the illumination system. In the illustrated example, the window 902 is a pop-up window that displays information for the luminaire depicted by the icon L14 when a cursor 904 hovers over the icon. In other implementations, the window 902 may be displayed when a user selects one of the icons L01-L23 using any suitable input selection method (e.g., touch, keyboard, manual entry).

The information provided in the map 900 or window 902 may be varied or configured as desired for a particular user or a particular application. For instance, a user may be interested in viewing only a particular subset of the luminaires in an illumination system. As non-limiting examples, a user may be interest in viewing only those luminaires that have an expected life of less than one year, only those luminaires that were installed within the past six months, or only those luminaires within a two-mile radius of a service depot. As another non-limiting example, the user may be interested in viewing only a subset of the luminaire information available for each luminaire, such as only the serial numbers of each of the luminaires.

For each of the luminaires L01, L04, L05, L06, L10, L11, L16 and L18, the map 900 provides an illustration of respective illumination patterns IP01, IP04, IP05, IP06, IP10, IP11, IP16 and IP18 (collectively illumination patterns IP). The illumination patterns IP are patterns the luminaires that have been set by an operator, as discussed above. In some implementations, an operator may be able to select (e.g., touch, click on) one or more of the luminaires L01-L23 displayed on the map 600, and selectively view or edit the illumination patterns of one or more of the luminaires.

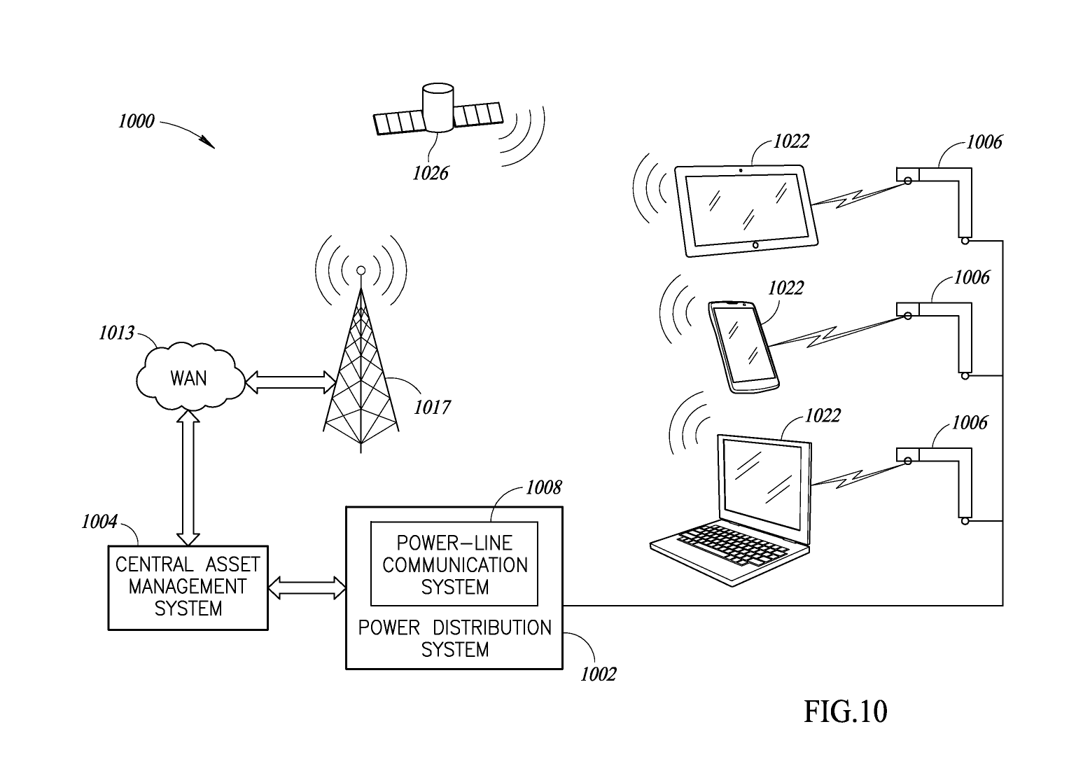

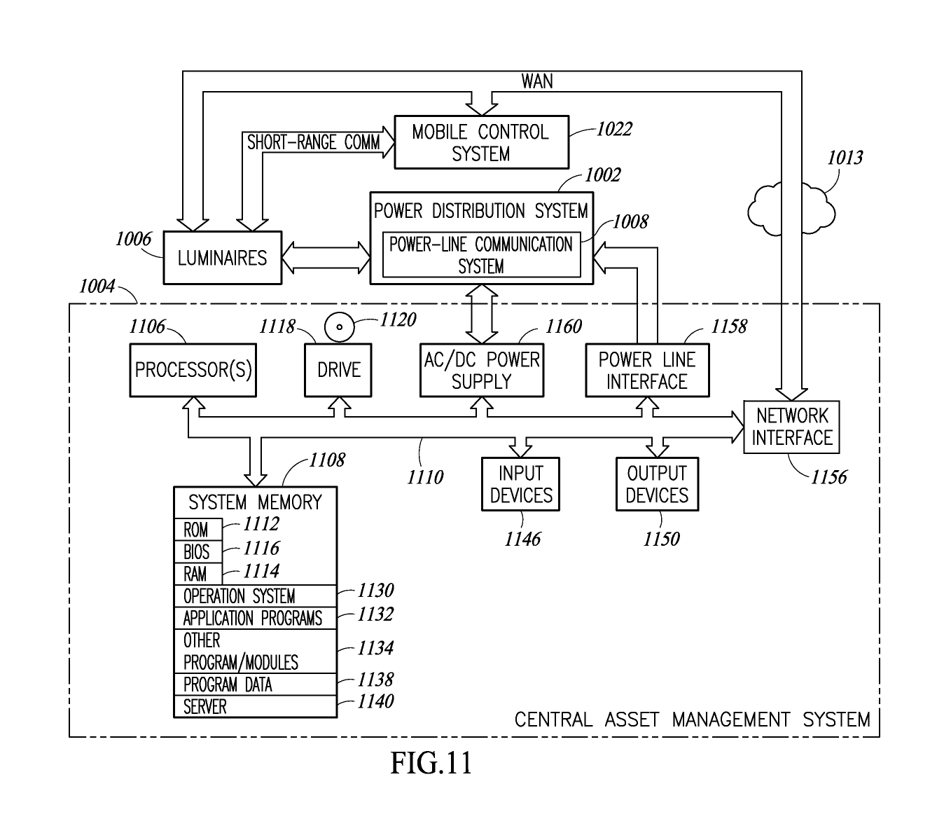

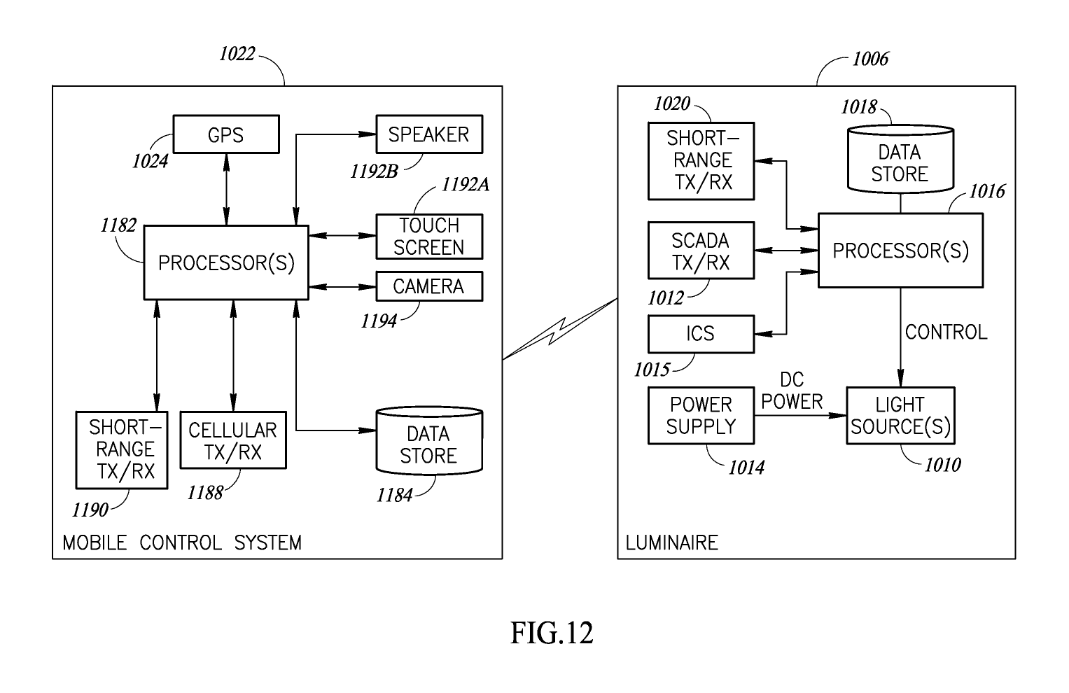

FIG. 10 illustrates a schematic block diagram of an illumination system 1000 that includes a power distribution system 1002, such as an alternating current (AC) network (e.g., power grid or mains) of a utility that includes one or more AC power sources, a central asset management system 1004, a plurality of outdoor luminaires 1006, and mobile control systems 1022 positioned proximate each of the luminaires. The particular functional features of the central asset management system 1004 are shown in FIG. 11, and the particular functional figures of the luminaires 1006 and the mobile control systems 1022 are shown in FIG. 12.

Three luminaires 1006 are shown in FIG. 10, but it should be appreciated that the number of luminaires may vary depending on a particular application. For example, for applications wherein the luminaires 1006 are part of an illumination system for a city, the number of luminaires may be in the hundreds or even thousands. As discussed further below, the central asset management system 1004 and the plurality of luminaires 1006 are communicatively coupled to a power-line communication system 1008 of the power distribution system 1002 to facilitate communications between the central asset management system and the plurality of luminaires via power lines of the power distribution system. In some implementations, the central asset management system 1004 may additionally or alternatively communicate with the plurality of luminaires 1006 via other types of networks or channels, such as one or more wired and/or wireless communications networks 1013. In the illustrated implementation, the luminaires 1006 may wirelessly communicate with an access point 1017 (e.g., cellular tower, WIFI® access point) operatively coupled to the one or more communication networks 1013.

As shown in FIG. 12, each luminaire 1006 includes one or more light sources 1010, a power-line transceiver 1012 (or other wired/wireless transceiver(s)), a power supply 1014, a local illumination control system (ICS) 1015, a luminaire processor 1016, a nontransitory data store 1018, and one or more wired/wireless short-range communications transceivers 1020 (e.g., Bluetooth®, Wi-Fi®, USW).

The transceivers 1012 or 1020 provide wired and/or wireless communications capabilities which allow the luminaires 1006 to be communicatively coupled with the central asset management system 1004 and one or more mobile control systems 1022. For example, in some instances the central asset management system may be implemented as a supervisory control and data acquisition (SCADA) system. In these instances, the transceiver(s) 1012 may include a SCADA transceiver that facilitates wireless communication and/or wired communication, such as communication over a power-line communication system.

The mobile control systems 1022 may include accurate location identification systems, such as global positioning system (GPS) receivers 1024 (FIG. 12) that communicate with GPS satellites 1026 (FIG. 10). The mobile control systems 1022 may also include one or more short-range wired or wireless communications capabilities, such as one or more of Bluetooth®, WiFi®, near field communication (NFC), ANT®, IEEE 802.15 (e.g., ZigBee), or USB®.

During installation, testing or setup of a luminaire 1006, the mobile control system 1022 positioned proximate the luminaire may transmit its location information (e.g., geographical coordinates) to the luminaire over a data communications channel (e.g., Bluetooth®, Wi-Fi®, USW). Since the location information is near the luminaire 1006 when the location information is determined, the luminaire may store the received location information as the luminaire's location in the data store 1018, for example. In some implementations, the luminaire may be equipped with a GPS receiver which may be used to obtain the time of day and location of the luminaire. In this regard, each of the installed luminaires “knows” its own geographical location.

In some implementations, each of the luminaires 1006 is programmed with a unique identifier (e.g., identification number, such as a serial number). The unique identifier uniquely identifies the respective luminaire with respect to all other luminaires in an installation, or installed base, asset collection, or inventory of an entity. The unique identifier may be programmed or otherwise stored in the nontransitory data store 1018 during manufacture, during installation, or at any other time. The unique identifier may be programmed using one of the mobile control systems 1022, a factory programming fixture, DIP switches, or using any other suitable method.

Once the luminaires 1006 have received their respective identification information and location information, the luminaires may send such information to the central asset management system 1004 for storage thereby. The central asset management system 1004 may also include mapping functions that generate an asset management map (FIG. 9) which may visually present luminaire information to one or more users. The central asset management system 1004 may also analyze the collected data and generate one or more electronic reports that are valuable for users associated with the illumination system 1000.

The local ICS 1015 may include a photocontrol that has a photosensitive transducer (photosensor) associated therewith. The ICS 1015 may be operative to control operation of the light sources 1010 based on ambient light levels detected by the photosensor. The ICS 1015 may be coupled to the processor 1016 and operative to provide illumination data signals to the processor so that the processor may control the light sources 1010 based on the received illumination data signals. The ICS 1015 may also be configured as a switch that provides electrical power to the light sources 1010 only when detected light levels are below a desired level. For example, the local ICS 1015 of the luminaire 1006 may include a photosensor that controls an electro-mechanical relay coupled between a source of electrical power and a control device (e.g., a magnetic or electronic transformer) within the luminaire. The electro-mechanical relay may be configured to be in an electrically continuous state unless a signal from the photosensor is present to supply power to the luminaire 1006. If the photosensor is illuminated with a sufficient amount of light, the photosensor outputs the signal that causes the electro-mechanical relay to switch to an electrically discontinuous state such that no power is supplied to the luminaire 1006.

In some implementations, the ICS 1015 may include one or more clocks or timers, and/or one or more look-up tables or other data structures that indicate dawn events and dusk events for one or more geographical locations at various times during a year. The time of occurrence of various solar events may additionally or alternatively be calculated using geolocation, time, or date data either generated by or stored within a nontransitory processor-readable medium of the luminaire 1006 or obtained from one or more external devices via one or more wired or wireless communication interfaces either in or communicably coupled to the luminaire. In some implementations, the ICS 1015 is implemented partially or fully by the processor 1016.

The power line transceiver 1012 and the power supply 1014 of the luminaire 1006 may each be electrically coupled with the power distribution system 1002 (FIG. 10). The power line transceiver 1012 may transmit and receive power line control or data signals over the power distribution system 1002, and the power supply 1014 may receive a power signal from the power distribution system. The power line transceiver 1012 may separate or decode the power line control or data signals from the power signals and may provide the decoded signals to the luminaire processor 1016. In turn, the luminaire processor 1016 may generate one or more light source control commands that are supplied to the light sources 1010 to control the operation thereof. The power line transceiver 1012 may also encode power line control or data signals and transmit the signals to the central asset management system 1004 via the power distribution system 1002.

The power supply 1014 may receive an AC power signal from the power distribution system 1002, generate a DC power output, and supply the generated DC power output to the light sources 1010 to power the light sources as controlled by light source control commands from the luminaire processor 1016.

The light sources 1010 may include one or more of a variety of conventional light sources, for example, incandescent lamps or fluorescent lamps such as high-intensity discharge (HID) lamps (e.g., mercury vapor lamps, high-pressure sodium lamps, metal halide lamps). The light sources 1010 may also include one or more solid-state light sources (e.g., light emitting diodes (LEDs), organic LEDs (OLEDs), polymer LEDs (PLEDs)).

The central asset management system 1004 may receive luminaire information from each of the luminaires 1006 in the illumination system 1000. For example, in some implementations the central asset management system 1004 may interrogate the luminaires 1006 (e.g., via the power distribution system 1002) and receive signals from each of the luminaires that provide luminaire information. In some implementations, the luminaires 1006 may automatically send luminaire information to the central asset management system without interrogation.

The central asset management system 1004 may store the luminaire information in one or more nontransitory computer- or processor-readable media. The luminaire information may include, for example, identification information, location information, installation date, illumination patterns, installation cost, installation details, type of luminaire, maintenance activities, specifications, purchase date, cost, expected lifetime, warranty information, service contracts, service history, spare parts, comments, or anything other information that may be useful to users (e.g., management, analysts, purchasers, installers, maintenance workers).

In some implementations, data communicated between the central asset management system 1004 and the luminaires 1006 may be converted into power line control signals that may be superimposed onto wiring of the power distribution system 1002 so that the signals are transmitted or distributed via the power distribution system. In some implementations, the power line signals may be in the form of amplitude modulation signals, frequency modulation signals, frequency shift keyed signals (FSK), differential frequency shift keyed signals (DFSK), differential phase shift keyed signals (DPSK), or other types of signals. The command code format of the power line signals may be that of a commercially available controller format or may be that of a custom controller format.

An example power line communication system is the TWACS® system available from Aclara Corporation, Hazelwood, Mo.

The central asset management system 1004 may utilize a power line transceiver or interface 1158 (see FIG. 11) that includes special coupling capacitors to connect transmitters to power-frequency AC conductors of the power distribution system 1002. Signals may be impressed on one conductor, on two conductors or on all three conductors of a high-voltage AC transmission line. Filtering devices may be applied at substations of the power distribution system 1002 to prevent the carrier frequency current from being bypassed through substation infrastructure. Power line carrier systems may be favored by utilities because they allow utilities to reliably move data over an infrastructure that they control.

In some instances, the power line signals may be in the form of a broadcast signal or command delivered to each of the luminaires 1006 in the illumination system 1000. In some instances, the power line signals may be specifically addressed to an individual luminaire 1006, or to one or more groups or subsets of luminaires.

FIGS. 11 and 12 and the following discussion provide a brief, general description of the components forming the illustrative illumination system 1000 including the central asset management system 1004, the power distribution system 1002, the mobile control systems 1022, and the luminaires 1006 in which the various illustrated implementations can be implemented. Although not required, some portion of the implementations will be described in the general context of computer-executable instructions or logic and/or data, such as program application modules, objects, or macros being executed by a computer. Those skilled in the relevant art will appreciate that the illustrated implementations as well as other implementations can be practiced with other computer system or processor-based device configurations, including handheld devices, for instance Web enabled cellular phones or PDAs, multiprocessor systems, microprocessor-based or programmable consumer electronics, personal computers (“PCs”), network PCs, minicomputers, mainframe computers, and the like. The implementations can be practiced in distributed computing environments where tasks or modules are performed by remote processing devices, which are linked through a communications network. In a distributed computing environment, program modules may be located in both local and remote memory storage devices.

The central asset management system 1004 may take the form of a PC, server, or other computing system executing logic or other machine executable instructions. The central asset management system 1004 includes one or more processors 1106, a system memory 1108 and a system bus 1110 that couples various system components including the system memory 1108 to the processor 1106. The central asset management system 1004 will at times be referred to in the singular herein, but this is not intended to limit the implementations to a single system, since in certain implementations, there will be more than one central asset management system 1004 or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The central asset management system 1004 may be implemented as a SCADA system or as one or more components thereof. Generally, a SCADA system is a system operating with coded signals over communication channels to provide control of remote equipment. The supervisory system may be combined with a data acquisition system by adding the use of coded signals over communication channels to acquire information about the status of the remote equipment for display or for recording functions.

The processor 1106 may be any logic processing unit, such as one or more central processing units (CPUs), microprocessors, digital signal processors (DSPs), graphics processors (GPUs), application-specific integrated circuits (ASICs), field programmable gate arrays (FPGAs), etc. Unless described otherwise, the construction and operation of the various blocks shown in FIGS. 11 and 12 are of conventional design. As a result, such blocks need not be described in further detail herein, as they will be understood by those skilled in the relevant art.

The system bus 1110 can employ any known bus structures or architectures. The system memory 1108 includes read-only memory (“ROM”) 1112 and random access memory (“RAM”) 1114. A basic input/output system (“BIOS”) 1116, which may be incorporated into at least a portion of the ROM 1112, contains basic routines that help transfer information between elements within the central asset management system 1004, such as during start-up. Some implementations may employ separate buses for data, instructions and power.

The central asset management system 1004 also may include one or more drives 1118 for reading from and writing to one or more nontransitory computer- or processor-readable media 1120 (e.g., hard disk, magnetic disk, optical disk). The drive 1118 may communicate with the processor 1106 via the system bus 1110. The drive 1118 may include interfaces or controllers (not shown) coupled between such drives and the system bus 1110, as is known by those skilled in the art. The drives 1118 and their associated nontransitory computer- or processor-readable media 1120 provide nonvolatile storage of computer-readable instructions, data structures, program modules and other data for the central asset management system 1004. Those skilled in the relevant art will appreciate that other types of computer-readable media may be employed to store data accessible by a computer.

Program modules can be stored in the system memory 1108, such as an operating system 1130, one or more application programs 1132, other programs or modules 1134, and program data 1138.

The application program(s) 1132 may include logic capable of providing the luminaire management functionality described herein. For example, applications programs 1132 may include programs to analyze and organize luminaire information automatically received from the luminaires 1006. The application programs 1132 may also include programs to present raw or analyzed illumination information in a format suitable for presentation to a user.

The system memory 1108 may include communications programs 1140 that permit the central asset management system 1004 to access and exchange data with other networked systems or components, such as the luminaires 1006, the mobile control systems 1022, and/or other computing devices.

While shown in FIG. 11 as being stored in the system memory 1108, the operating system 1130, application programs 1132, other programs/modules 1134, program data 1138 and communications 1140 can be stored on the nontransitory computer- or processor-readable media 1120 or other nontransitory computer- or processor-readable media.

Personnel can enter commands (e.g., system maintenance, upgrades) and information (e.g., parameters) into the central asset management system 1004 using one or more communicably coupled input devices 1146 such as a touch screen or keyboard, a pointing device such as a mouse, and/or a push button. Other input devices can include a microphone, joystick, game pad, tablet, scanner, biometric scanning device, etc. These and other input devices may be connected to the processor 1106 through an interface such as a universal serial bus (“USB”) interface that couples to the system bus 1110, although other interfaces such as a parallel port, a game port or a wireless interface or a serial port may be used. One or more output devices 1150, such as a monitor or other display device, may be coupled to the system bus 1110 via a video interface, such as a video adapter. In at least some instances, the input devices 1146 and the output devices 1150 may be located proximate the central asset management system 1004, for example when the system is installed at the system user's premises. In other instances, the input devices 1146 and the output devices 1150 may be located remote from the central asset management system 1004, for example, when the system is installed on the premises of a service provider.

In some implementations, the central asset management system 1004 uses one or more of the logical connections to optionally communicate with one or more luminaires 1006, remote computers, servers and/or other devices via one or more communications channels, for example, the one or more networks 1013. These logical connections may facilitate any known method of permitting computers to communicate, such as through one or more LANs and/or WANs. Such networking environments are known in wired and wireless enterprise-wide computer networks, intranets, extranets, and the Internet.

In some implementations, a network port or interface 1156, communicatively linked to the system bus 1110, may be used for establishing and maintaining communications over the communications network 1013.

The central asset management system 1004 may include a power line transceiver or interface 1158 and an AC/DC power supply 1160 that are each electrically coupled to the power distribution system 1002. The AC/DC power supply 1160 converts AC power from the power distribution system 1002 into DC power, which may be provided to power the various components of the central asset management system 1004. As discussed above, the power line interface 1158 may be operative to superimpose control signals onto one or more conductors of the power distribution system 1002 that carries power to the luminaires 1006. The power line interface 1158 may also be operative to decode and receive communication signals sent over the power distribution system 1002 (e.g., from the power line interface 1012 of a luminaire 1006 (FIG. 10)).

In some implementations, the central asset management system 1004 may utilize the one or more wired and/or wireless communications networks 1013 to communicate with the luminaires 1006 instead of or in addition to communicating through the power distribution system 1002.

In the illumination system 1000, program modules, application programs, or data, or portions thereof, can be stored in one or more computing systems. Those skilled in the relevant art will recognize that the network connections shown in FIG. 11 are only some examples of ways of establishing communications between computers, and other connections may be used, including wireless. In some implementations, program modules, application programs, or data, or portions thereof, can even be stored in other computer systems or other devices (not shown).

For convenience, the processor 1106, system memory 1108, network port 1156 and devices 1146, 1150 are illustrated as communicatively coupled to each other via the system bus 1110, thereby providing connectivity between the above-described components. In alternative implementations, the above-described components may be communicatively coupled in a different manner than illustrated in FIG. 11. For example, one or more of the above-described components may be directly coupled to other components, or may be coupled to each other, via intermediary components (not shown). In some implementations, system bus 1110 is omitted and the components are coupled directly to each other using suitable connections.

It should be appreciated that the luminaires 1006 may include components similar to those components present in the central asset management system 1004, including the processor 1106, power supply 1160, power line interface 1158, buses, nontransitory computer- or processor-readable media, wired or wireless communications interfaces, and one or more input and/or output devices.

The mobile control system 1022 can include any device, system or combination of systems and devices having at least wired or wireless communications capabilities. In most instances, the mobile control system 1022 includes additional devices, systems, or combinations of systems and devices capable of providing graphical data display capabilities. Examples of such mobile control systems 1022 can include without limitation, cellular telephones, smart phones, tablet computers, desktop computers, laptop computers, ultraportable or netbook computers, personal digital assistants, handheld devices, other smart appliances, and the like.

In other implementations, the luminaire includes a satellite positioning receiver such as GPS receiver, Glonass, etc., and stores its position data in nontransitory computer- or processor-readable media or memory. The position data may only need to be acquired relatively infrequently, thus enabling location data to be acquired in poor reception areas or with relatively low cost receiver hardware.

The mobile control system 1022 may include one or more processors 1182 and nontransitory computer- or processor-readable media or memory, for instance one or more data stores 1184 that may include nonvolatile memories such as read only memory (ROM) or FLASH memory and/or one or more volatile memories such as random access memory (RAM).

The mobile control system 1022 may include one or more transceivers or radios and associated antennas. For example, the mobile control system 1022 may include one or more cellular transceivers or radios 1188 and one or more short-range transceivers or radios 1190, such as WIFI® transceivers or radios, BLUETOOTH® transceivers or radios, along with associated antennas. The mobile control system 1022 may further include one or more wired interfaces (not shown) that utilize parallel cables, serial cables, or wireless channels capable of high speed communications, for instance, via one or more of FireWire®, Universal Serial Bus® (USB), Thunderbolt®, or Gigabit Ethernet®, for example.

The mobile control system 1022 may include a user input/output subsystem, for example including a touchscreen or touch sensitive display device 1192A and one or more speakers 1192B. The touchscreen or touch sensitive display device 1192A may include any type of touchscreen including, but not limited to, a resistive touchscreen or a capacitive touchscreen. The touchscreen or touch sensitive display device 1192A may present a graphical user interface, for example in the form of a number of distinct screens or windows, which include prompts and/or fields for selection. The touchscreen or touch sensitive display device 1192A may present or display individual icons and controls, for example virtual buttons or slider controls and virtual keyboard or key pads which are used to communicate instructions, commands, and/or data. While not illustrated, the user interface may additionally or alternatively include one or more additional input or output devices, for example an alphanumeric keypad, a QWERTY keyboard, a joystick, scroll wheel, touchpad or similar physical or virtual input device.

In some implementations, the touchscreen 1192A or other input component may include simple adjustment “sliders” to set the current to individual LED arrays. More sophisticated graphical user interfaces (GUIs) may also be used, for example, buttons for selecting NEMA Type 1, NEMA Type 2, or other illumination pattern standards, scheduled dimming selection and other features. The LED driver channel current, dimming schedule, GPS coordinates and other data may be transmitted wirelessly to the luminaire, where such data are stored (e.g., in the data store 1184).

The mobile control system 1022 may include one or more image capture devices 1194, for example, cameras with suitable lenses, and optionally one or more flash or lights for illuminating a field of view to capture images. The image capture device(s) 1194 may capture still digital images or moving or video digital images. Image information may be stored as files via the data store 1184, for example.

Some or all of the components within the mobile control system 1022 may be communicably coupled using at least one bus (not shown) or similar structure adapted to transferring, transporting, or conveying data between the devices, systems, or components used within the mobile control system 1022. The bus can include one or more serial communications links or a parallel communications link such as an 8-bit, 16-bit, 32-bit, or 64-bit data bus. In some implementations, a redundant bus (not shown) may be present to provide failover capability in the event of a failure or disruption of a primary bus.

The processor(s) 1182 may include any type of processor (e.g., ARM Cortext-A8, ARM Cortext-A9, Snapdragon 600, Snapdragon 800, NVidia Tegra 4, NVidia Tegra 4i, Intel Atom Z2580, Samsung Exynos 5 Octa, Apple A7, Motorola X8) adapted to execute one or more machine executable instruction sets, for example a conventional microprocessor, a reduced instruction set computer (RISC) based processor, an application specific integrated circuit (ASIC), digital signal processor (DSP), or similar. Within the processor(s) 1182, a non-volatile memory may store all or a portion of a basic input/output system (BIOS), boot sequence, firmware, startup routine, and communications device operating system (e.g., iOS®, Android®, Windows® Phone, Windows® 8, and similar) executed by the processor 1182 upon initial application of power. The processor(s) 1182 may also execute one or more sets of logic or one or more machine executable instruction sets loaded from volatile memory subsequent to the initial application of power to the processor 1182. The processor 1182 may also include a system clock, a calendar, or similar time measurement devices. One or more geolocation devices, for example a Global Positioning System (GPS) receiver 1024 may be communicably coupled to the processor 1182 to provide additional functionality such as geolocation data to the processor 1182.

The transceivers or radios 1188, 1190 can include any device capable of transmitting and receiving communications via electromagnetic energy.

Non-limiting examples of cellular communications transceivers or radios 1188 include a CDMA transceiver, a GSM transceiver, a 3G transceiver, a 4G transceiver, an LTE transceiver, and any similar current or future developed computing device transceiver having at least one of a voice telephony capability or a data exchange capability. In at least some instances, the cellular transceivers or radios 1188 can include more than one interface. For example, in some instances, the cellular transceivers or radios 1188 can include at least one dedicated, full- or half-duplex, voice call interface and at least one dedicated data interface. In other instances, the cellular transceivers or radios 1188 can include at least one integrated interface capable of contemporaneously accommodating both full- or half-duplex voice calls and data transfer.

Non-limiting examples of WIFI® short-range transceivers or radios 1190 include various chipsets available from Broadcom, including BCM43142, BCM4313, BCM94312MC, BCM4312, and chipsets available from Atmel, Marvell, or Redpine. Non-limiting examples of Bluetooth® short-range transceivers or radios 1188 include various chipsets available from Nordic Semiconductor, Texas Instruments, Cambridge Silicon Radio, Broadcom, and EM Microelectronic.

As noted, the data store 1184 can include non-volatile storage memory and in some implementations may include volatile memory as well. At least a portion of the data store 1184 may be used to store one or more processor executable instruction sets for execution by the processor 1182. In some implementations, all or a portion of the memory may be disposed within the processor 1182, for example in the form of a cache. In some implementations, the memory may be supplemented with one or more slots configured to accept the insertion of one or more removable memory devices such as a secure digital (SD) card, a compact flash (CF) card, a universal serial bus (USB) memory “stick,” or the like.

In at least some implementations, one or more sets of logic or machine executable instructions providing applications or “apps” executable by the processor 1182 may be stored in whole or in part in at least a portion of the memory 1184. In at least some instances, the applications may be downloaded or otherwise acquired by the end user, for example using an online marketplace such as the Apple App Store, Amazon Marketplace, or Google Play marketplaces. In some implementations, such applications may start up in response to selection of a corresponding user selectable icon by the user or consumer. The application can facilitate establishing a data link between the mobile control system 1022 and the central asset management system 1004 or the luminaires 1006 via the transceivers or radios 1188, 1190 and communication networks 1013.

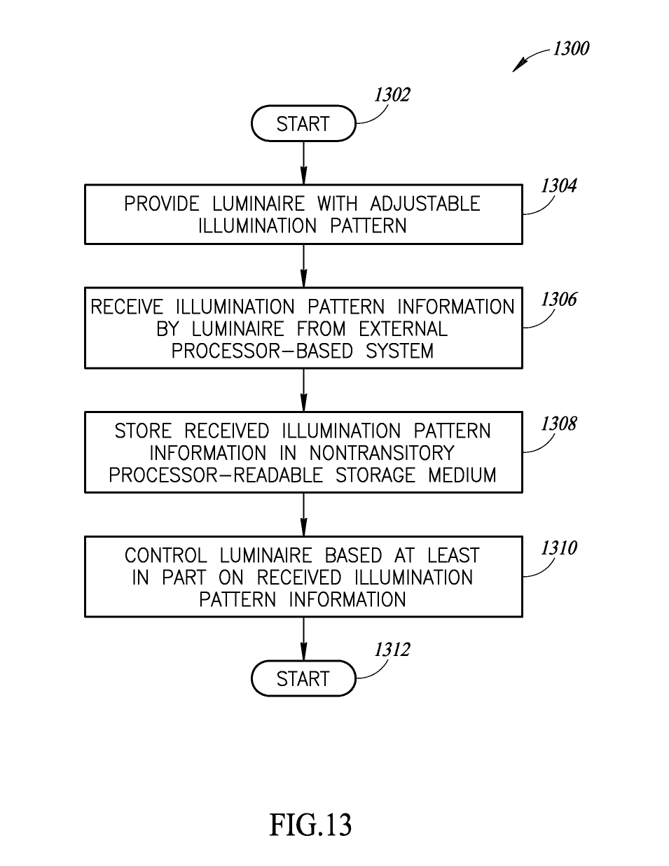

FIG. 13 is a flow diagram showing a method 1300 of operation of a processor-based device to provide installed luminaires in an illumination system with illumination pattern information. The method 1300 starts at 1302. For example, the method 1300 may start in response to commissioning an illumination system, such as the illumination system 1000 shown in FIG. 10. The method 1300 may also start in response to a need to modify an illumination pattern of a luminaire after installation.

At 1304, a luminaire is provided that includes a housing having a circuit board mounting area. The luminaire also includes at least one circuit board physically coupled to the circuit board mounting area. A number N of solid-state light emitter arrays are carried on the at least one circuit board. Each of the N solid-state light emitter arrays includes a plurality of solid-state light emitters. As discussed above, at least some of the plurality of solid-state light emitters of one of the N solid-state light emitter arrays positioned at a different angle from at least some of the solid-state light emitters of at least one of the other N solid-state light emitter arrays. The luminaire also includes a solid-state light emitter driver including N independently controllable driver channels, at least one luminaire processor operatively coupled to the solid-state light emitter driver to control the operation thereof and at least one luminaire transceiver operatively coupled to the at least one luminaire processor and to at least one data communications channel. The luminaire further includes at least one luminaire nontransitory processor-readable storage medium operatively coupled to the at least one luminaire processor.

At 1306, the luminaire receives, by the at least one luminaire transceiver, illumination pattern information from a remotely located external processor-based system over the at least one data communications channel. As noted above, the illumination pattern information is indicative of an illumination pattern to be produced by the N solid-state light emitter arrays. As an example, the luminaire may receive the illumination pattern information over a power line distribution system (e.g., PLC). The luminaire may also receive the luminaire pattern information wirelessly from a mobile control system positioned proximate to the luminaire. Examples of mobile control systems can include without limitation, cellular telephones, smart phones, tablet computers, desktop computers, laptop computers, ultraportable or netbook computers, personal digital assistants, handheld devices, other smart appliances, and the like. For instance, an installer or technician may stand near an installed luminaire with a mobile control system during installation, testing, modification or setup of the luminaire. As noted above, the mobile control system includes illumination pattern information that may be provided to the luminaire. In some implementations, the mobile control system may include an interface that allows a user to manually input illumination pattern information (e.g., NEMA Type beam pattern, custom beam angles, custom beam shapes) into the mobile control system.

At 1308, the luminaire may store the received illumination pattern information on the at least one nontransitory processor-readable storage medium. At 1310, the luminaire may control the operation of the solid-state light emitter driver based at least in part on the illumination pattern information.

The method 1300 ends at 1312 until started or invoked again. For example, the method 1300 may be performed for each luminaire in an illumination system during setup of the luminaire or when an illumination pattern for the luminaire is to be modified. The method 1300 may also be repeated for a luminaire after certain events, such as a maintenance event or a relocation event.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and/or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, and U.S. patent applications referred to in this specification and/or listed in the Application Data Sheet, including but not limited to

U.S. Provisional Patent Application No. 61/052,924, filed May 13, 2008; U.S. Pat. No. 8,926,138, issued Jan. 6, 2015; PCT Publication No. WO2009/140141, published Nov. 19, 2009; U.S. Provisional Patent Application No. 61/051,619, filed May 8, 2008; U.S. Pat. No. 8,118,456, issued Feb. 21, 2012; PCT Publication No. WO2009/137696, published Nov. 12, 2009; U.S. Provisional Patent Application No. 61/088,651, filed Aug. 13, 2008; U.S. Pat. No. 8,334,640, issued Dec. 18, 2012; U.S. Provisional Patent Application No. 61/115,438, filed Nov. 17, 2008; U.S. Provisional Patent Application No. 61/154,619, filed Feb. 23, 2009; U.S. Patent Publication No. 2010/0123403, published May 20, 2010; U.S. Non-provisional Patent application Ser. No. 14/806,500, filed Jul. 22, 2015; PCT Publication No. WO2010/057115, published May 20, 2010; U.S. Provisional Patent Application No. 61/174,913, filed May 1, 2009; U.S. Pat. No. 8,926,139, issued Jan. 6, 2015; PCT Publication No. WO2010/127138, published Nov. 4, 2010; U.S. Provisional Patent Application No. 61/180,017, filed May 20, 2009; U.S. Pat. No. 8,872,964, issued Oct. 28, 2014; U.S. Patent Publication No. 2015/0015716, published Jan. 15, 2015; PCT Publication No. WO2010/135575, published Nov. 25, 2010; U.S. Provisional Patent Application No. 61/229,435, filed Jul. 29, 2009; U.S. Patent Publication No. 2011/0026264, published Feb. 3, 2011; U.S. Provisional Patent Application No. 61/295,519, filed Jan. 15, 2010; U.S. Provisional Patent Application No. 61/406,490, filed Oct. 25, 2010; U.S. Pat. No. 8,378,563, issued Feb. 19, 2013; PCT Publication No. WO2011/088363, published Jul. 21, 2011; U.S. Provisional Patent Application No. 61/333,983, filed May 12, 2010; U.S. Pat. No. 8,541,950, issued Sep. 24, 2013; PCT Publication No. WO2010/135577, published Nov. 25, 2010; U.S. Provisional Patent Application No. 61/346,263, filed May 19, 2010; U.S. Pat. No. 8,508,137, issued Aug. 13, 2013; U.S. Pat. No. 8,810,138, issued Aug. 19, 2014; U.S. Pat. No. 8,987,992, issued Mar. 24, 2015; PCT Publication No. WO2010/135582, published Nov. 25, 2010; U.S. Provisional Patent Application No. 61/357,421, filed Jun. 22, 2010; U.S. Patent Publication No. 2011/0310605, published Dec. 22, 2011; PCT Publication No. WO2011/163334, published Dec. 29, 2011; U.S. Pat. No. 8,901,825, issued Dec. 2, 2014; U.S. Patent Publication No. 2015/0084520, published Mar. 26, 2015; PCT Publication No. WO2012/142115, published Oct. 18, 2012; U.S. Pat. No. 8,610,358, issued Dec. 17, 2013; U.S. Provisional Patent Application No. 61/527,029, filed Aug. 24, 2011; U.S. Pat. No. 8,629,621, issued Jan. 14, 2014; PCT Publication No. WO2013/028834, published Feb. 28, 2013; U.S. Provisional Patent Application No. 61/534,722, filed Sep. 14, 2011; U.S. Patent Publication No. 2013/0062637, published Mar. 14, 2013; PCT Publication No. WO2013/040333, published Mar. 21, 2013; U.S. Provisional Patent Application No. 61/567,308, filed Dec. 6, 2011; U.S. Patent Publication No. 2013/0163243, published Jun. 27, 2013; U.S. Provisional Patent Application No. 61/561,616, filed Nov. 18, 2011; U.S. Patent Publication No. 2013/0141010, published Jun. 6, 2013; PCT Publication No. WO2013/074900, published May 23, 2013; U.S. Provisional Patent Application No. 61/641,781, filed May 2, 2012; U.S. Patent Publication No. 2013/0293112, published Nov. 7, 2013; U.S. Patent Publication No. 2013/0229518, published Sep. 5, 2013; U.S. Provisional Patent Application No. 61/640,963, filed May 1, 2012; U.S. Patent Publication No. 2013/0313982, published Nov. 28, 2013; U.S. Patent Publication No. 2014/0028198, published Jan. 30, 2014; U.S. Non-provisional patent application Ser. No. 14/816,754, filed Aug. 3, 2015; PCT Publication No. WO2014/018773, published Jan. 30, 2014; U.S. Provisional Patent Application No. 61/723,675, filed Nov. 7, 2012; U.S. Patent Publication No. 2014/0159585, published Jun. 12, 2014; U.S. Provisional Patent Application No. 61/692,619, filed Aug. 23, 2012; U.S. Patent Publication No. 2014/0055990, published Feb. 27, 2014; U.S. Provisional Patent Application No. 61/694,159, filed Aug. 28, 2012; U.S. Pat. No. 8,878,440, issued Nov. 4, 2014; U.S. Patent Publication No. 2014/0062341, published Mar. 6, 2014; U.S. Patent Publication No. 2015/0077019, published Mar. 19, 2015; PCT Publication No. WO2014/039683, published Mar. 13, 2014; U.S. Provisional Patent Application No. 61/728,150, filed Nov. 19, 2012; U.S. Patent Publication No. 2014/0139116, published May 22, 2014; PCT Publication No. WO2014/078854, published May 22, 2014; U.S. Provisional Patent Application No. 61/764,395, filed Feb. 13, 2013; U.S. Patent Publication No. 2014/0225521, published Aug. 14, 2014; U.S. Provisional Patent Application No. 61/849,841, filed Jul. 24, 2013; U.S. Patent Publication No. 2015/0028693, published Jan. 29, 2015; PCT Publication No. WO2015/013437, published Jan. 29, 2015; U.S. Provisional Patent Application No. 61/878,425, filed Sep. 16, 2013; U.S. Patent Publication No. 2015/0078005, published Mar. 19, 2015; PCT Publication No. WO2015/039120, published Mar. 19, 2015; U.S. Provisional Patent Application No. 61/933,733, filed Jan. 30, 2014; U.S. Pat. No. 9,185,777, issued Nov. 10, 2015; PCT Publication No. WO2015/116812, published Aug. 6, 2015; U.S. Provisional Patent Application No. 61/905,699, filed Nov. 18, 2013; U.S. Patent Publication No. 2015/0137693, published May 21, 2015; U.S. Provisional Patent Application No. 62/068,517, filed Oct. 24, 2014; U.S. Provisional Patent Application No. 62/183,505, filed Jun. 23, 2015; U.S. Non-provisional patent application Ser. No. 14/869,492, filed Sep. 29, 2015; PCT Application No. PCT/US2015/53000, filed Sep. 29, 2015; U.S. Provisional Patent Application No. 62/082,463, filed Nov. 20, 2014; U.S. Non-provisional patent application Ser. No. 14/869,501, filed Sep. 29, 2015; PCT Application No. PCT/US2015/53006, filed Sep. 29, 2015; U.S. Provisional Patent Application No. 62/057,419, filed Sep. 30, 2014; U.S. Non-provisional patent application Ser. No. 14/869,511, filed Sep. 29, 2015; PCT Application No. PCT/US2015/53009, filed Sep. 29, 2015; U.S. Provisional Patent Application No. 62/114,826, filed Feb. 11, 2015; U.S. Provisional Patent Application No. 62/137,666, filed Mar. 24, 2015; U.S. Non-provisional patent application Ser. No. 14/844,944, filed Sep. 3, 2015; U.S. Provisional Patent Application No. 62/208,403, filed Aug. 21, 2015 are incorporated herein by reference in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A luminaire, comprising:
a housing comprising a heat exchanger having a circuit board mounting area;
at least one circuit board physically coupled to the circuit board mounting area of the heat exchanger;
a number N of solid-state light emitter arrays carried on the at least one circuit board, the number N greater than or equal to two, each of the N solid-state light emitter arrays including a plurality of solid-state light emitters, at least some of the plurality of solid-state light emitters of one of the N solid-state light emitter arrays positioned at a different angle from at least some of the solid-state light emitters of at least one of the other N solid-state light emitter arrays;
a solid-state light emitter driver including N independently controllable driver channels, each of the N driver channels electrically coupled to a different one of the N solid-state light emitter arrays;
at least one luminaire processor operatively coupled to the solid-state light emitter driver to control the operation thereof;
at least one luminaire transceiver operatively coupled to the at least one luminaire processor and to at least one data communications channel; and
at least one luminaire nontransitory processor-readable storage medium operatively coupled to the at least one luminaire processor and which stores at least one of data or instructions which, when executed by the at least one luminaire processor, cause the at least one luminaire processor to:
receive, via the at least one luminaire transceiver, illumination pattern information from a remotely located external processor-based system over the at least one data communications channel, the illumination pattern information indicative of an illumination pattern to be produced by the N solid-state light emitter arrays;
store the received illumination pattern information in the at least one nontransitory processor-readable storage medium; and
control the operation of the solid-state light emitter driver based at least in part on the illumination pattern information.

2. The luminaire of claim 1 wherein the received illumination pattern information specifies an instruction to control the solid-state light emitter driver to drive at least one of the N independently controllable driver channels differently from the other of the N independently controllable driver channels.

3. The luminaire of claim 1 wherein the received illumination pattern information specifies an instruction to control the solid-state light emitter driver to drive each of the N independently controllable driver channels so that the plurality of solid-state light emitters of the N solid-state light emitter arrays produce at least one of a plurality of determined standardized illumination patterns.

4. The luminaire of claim 1 wherein the received illumination pattern information specifies an instruction to control the solid-state light emitter driver to drive each of the N independently controllable driver channels so that the plurality of solid-state light emitters of the N solid-state light emitter arrays produce at least one of a National Electrical Manufacturers Association (NEMA) illumination pattern or an Illuminating Engineering Society of North America (IESNA) illumination pattern.

5. The luminaire of claim 1 wherein the received illumination pattern information specifies an instruction to control the solid-state light emitter driver to drive each of the N independently controllable driver channels so that each of the plurality of solid-state light emitters of at least one of the N solid-state light emitter arrays are at least one of disabled or dimmed.

6. The luminaire of claim 1 wherein the circuit board mounting area of the heat exchanger comprises a curved downward facing mounting surface of the housing.

7. The luminaire of claim 1 wherein the circuit board mounting area of the housing has longitudinal dimension and a lateral dimension perpendicular to the longitudinal dimension, the circuit board mounting area curved along the lateral dimension and the longitudinal dimension, and the at least one circuit board has longitudinal dimension and a lateral dimension perpendicular to the longitudinal dimension, the at least one circuit board is physically coupled to the circuit board mounting area such that the longitudinal dimension of the at least one circuit board is curved along the longitudinal dimension of the circuit board mounting area and the lateral dimension of the at least one circuit board is curved along the lateral dimension of the circuit board mounting area.

8. The luminaire of claim 1 wherein the at least one circuit board is a flexible printed circuit board.

9. The luminaire of claim 1, further comprising:
a thermally conductive interface material positioned between at least a portion of the at least one circuit board and the circuit board mounting area.

10. The luminaire of claim 1 wherein the plurality of solid-state light emitters of a first one of the N solid-state light emitter arrays produces light of a first color, and the plurality of solid-state light emitters of a second one of the N solid-state light emitter arrays produces light of a second color, the second color different from the first color.

11. The luminaire of claim 10 wherein the first color is white and the second color is amber.

12. The luminaire of claim 1 wherein the heat exchanger comprises a boss extending downwardly from the housing, and the circuit board mounting area comprises at least one surface of the boss parallel to an optical axis of the luminaire.

13. The luminaire of claim 12 wherein the boss is cylindrically shaped, and the circuit board mounting area comprises a sidewall of the boss.

14. The luminaire of claim 12 wherein the boss has a four orthogonal side walls extending parallel to the optical axis of the luminaire, each of the solid-state light emitter arrays mounted adjacent a different one of the four side walls.

15. The luminaire of claim 12 wherein the boss has a N side walls extending parallel to the optical axis of the luminaire, each of the N solid-state light emitter arrays mounted adjacent a different one of the N side walls.

16. The luminaire of claim 1 wherein the at least one circuit board is at least one flexible printed circuit board and at least a portion of the circuit board mounting area is a curved surface.

17. The luminaire of claim 1 wherein the at least one luminaire transceiver receives the illumination pattern information from the external processor-based system over at least one of a Bluetooth®, WiFi®, near field communication (NFC), ANT®, or IEEE 802.15 channel.

18. The luminaire of claim 1 wherein the at least one luminaire transceiver receives the illumination pattern information from the external processor-based system over at least one of a short-range wireless channel or a wired communications channel.

19. The luminaire of claim 1 wherein the at least one luminaire transceiver receives the illumination pattern information from the external processor-based system through at least one power-line power distribution system.

20. The luminaire of claim 1 wherein the at least one luminaire transceiver receives the illumination pattern information from at least one of a smartphone, a tablet computer, or a notebook computer.

21. The luminaire of claim 1 wherein the at least one luminaire transceiver receives the illumination pattern information from the external processor-based system over the at least one data communications channel, the illumination pattern information indicative of a notification illumination pattern to be produced by the N solid-state light emitter arrays, the notification illumination pattern provides a notification to humans that view the luminaire when the plurality of solid-state light emitters are illuminated according to the notification illumination pattern.

22. A method of operation for a luminaire, the method comprising:
providing a luminaire that includes:
a housing comprising a heat exchanger having a circuit board mounting area;
at least one circuit board physically coupled to the circuit board mounting area of the heat exchanger;
a number N of solid-state light emitter arrays carried on the at least one circuit board, the number N greater than or equal to two, each of the N solid-state light emitter arrays including a plurality of solid-state light emitters, at least some of the plurality of solid-state light emitters of one of the N solid-state light emitter arrays positioned at a different angle from at least some of the solid-state light emitters of at least one of the other N solid-state light emitter arrays;
a solid-state light emitter driver including N independently controllable driver channels, each of the N driver channels electrically coupled to a different one of the N solid-state light emitter arrays;
at least one luminaire processor operatively coupled to the solid-state light emitter driver to control the operation thereof;
at least one luminaire transceiver operatively coupled to the at least one luminaire processor and to at least one data communications channel; and
at least one luminaire nontransitory processor-readable storage medium operatively coupled to the at least one luminaire processor;
receiving, by the at least one luminaire transceiver, illumination pattern information from a remotely located external processor-based system over the at least one data communications channel, the illumination pattern information indicative of an illumination pattern to be produced by the N solid-state light emitter arrays;
storing the received illumination pattern information in the at least one nontransitory processor-readable storage medium; and
controlling the operation of the solid-state light emitter driver based at least in part on the illumination pattern information.

23. The method of claim 22 wherein receiving illumination pattern information comprises receiving an illumination pattern information that specifies an instruction to control the solid-state light emitter driver to drive at least one of the N independently controllable driver channels differently from the other of the N independently controllable driver channels.

24. The method of claim 22 wherein receiving illumination pattern information comprises receiving an illumination pattern information that specifies an instruction to control the solid-state light emitter driver to drive each of the N independently controllable driver channels so that the plurality of solid-state light emitters of the N solid-state light emitter arrays produce a determined standardized illumination pattern.

25. The method of claim 22 wherein receiving illumination pattern information comprises receiving an illumination pattern information that specifies an instruction to control the solid-state light emitter driver to drive each of the N independently controllable driver channels so that the plurality of solid-state light emitters of the N solid-state light emitter arrays produce at least one of a National Electrical Manufacturers Association (NEMA) illumination pattern or an Illuminating Engineering Society of North America (IESNA) illumination pattern.

26. The method of claim 22 wherein receiving illumination pattern information comprises receiving an illumination pattern information that specifies an instruction to control the solid-state light emitter driver to drive each of the N independently controllable driver channels so that each of the plurality of solid-state light emitters of at least one of the N solid-state light emitter arrays are disabled.

27. The method of claim 22 wherein the plurality of solid-state light emitters of a first one of the N solid-state light emitter arrays produce light of a first color, and the plurality of solid-state light emitters of a second one of the N solid-state light emitter arrays produce light of a second color, the second color different from the first color, the method further comprising:
controlling the operation of the solid-state light emitter driver based at least in part on the illumination pattern information to cause the luminaire to emit light of at least one of the first color or the second color.

28. The method of claim 22 wherein receiving illumination pattern information comprises receiving illumination pattern information from the external processor-based system over at least one of a Bluetooth®, WiFi®, near field communication (NFC), ANT®, or IEEE 802.15 channel.

29. The method of claim 22 wherein receiving illumination pattern information comprises receiving illumination pattern information from the external processor-based system over at least one of a short-range wireless channel or a wired communications channel.

30. The method of claim 22 wherein receiving illumination pattern information comprises receiving illumination pattern information from the external processor-based system through at least one power-line power distribution system.

31. The method of claim 22 wherein receiving illumination pattern information comprises receiving illumination pattern information from at least one of a smartphone, a tablet computer, or a notebook computer.

32. The method of claim 22 wherein receiving illumination pattern information comprises receiving illumination pattern information from the external processor-based system over the at least one data communications channel, the illumination pattern information indicative of a notification illumination pattern to be produced by the N solid-state light emitter arrays, the notification illumination pattern providing a notification to humans that view the luminaire when the plurality of solid-state light emitters are illuminated according to the notification illumination pattern.

33. A mobile control system (MCS) to provide illumination pattern information to a luminaire, the luminaire comprising a number N of solid-state light emitter arrays that each include a plurality of solid-state light emitters, the luminaire further including at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor, the MCS comprising:
at least one MCS processor;
at least one MCS transceiver operatively coupled to the at least one MCS processor and to at least one data communications channel; and
at least one MCS nontransitory processor-readable storage medium operatively coupled to the at least one MCS processor and storing at least one of data or instructions which, when executed by the at least one MCS processor, cause the at least one MCS processor to:
send, via the at least one MCS transceiver, illumination pattern information to the luminaire over the at least one data communications channel for storage on the at least one luminaire nontransitory processor-readable storage medium, the illumination pattern information indicative of an illumination pattern to be produced by the N solid-state light emitter arrays.

34. The MCS of claim 33 wherein the data communications channel comprises at least one of a Bluetooth®, WiFi®, near field communication (NFC), ANT®, or IEEE 802.15 channel.

35. The MCS of claim 33 wherein the MCS comprises at least one of a smartphone, a tablet computer, or a notebook computer.

36. A method of operation to control a plurality of remotely located luminaires in an illumination system, each of the plurality of luminaires comprising a number N of solid-state light emitter arrays that each include a plurality of solid-state light emitters, at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor, the method comprising:
for each of the plurality of luminaires,
positioning a mobile control system (MCS) proximate the luminaire, the MCS storing illumination pattern information indicative of an illumination pattern to be produced by the N solid-state light emitter arrays of the luminaire;
sending, by the MCS, the illumination pattern information to the luminaire over at least one data communications channel; and
storing, by at least one luminaire processor of the luminaire, the illumination pattern information in a nontransitory processor-readable storage medium.

37. The method of claim 36 wherein sending illumination pattern information comprises sending illumination pattern information through at least one wireless communications channel.

38. The method of claim 36 wherein sending illumination pattern information comprises sending illumination pattern information through at least one power-line power distribution system.

39. The method of claim 36 wherein sending illumination pattern information to the luminaire comprises sending illumination pattern information to the luminaire via at least one of a smartphone, tablet computer, or notebook computer.
